(19) United States
(12) Patent Application Publication
(10) Pub. No.: US 2026/0313535 A1
(43) Pub. Date: Oct. 8, 2026

(54) INFORMATION PROCESSING METHOD AND APPARATUS, COMMUNICATION DEVICE, COMMUNICATION SYSTEM, AND STORAGE MEDIUM

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/478,628

(22) PCT Filed: Apr. 28, 2023
(86) PCT No.: PCT/CN2023/091892

§ 371 Date: Oct. 24, 2025

(51) Int. Cl. H04W 52/02; H04W 76/28

(52) U.S. Cl. CPC H04W 52/0206; H04W 76/28

(57) ABSTRACT

Embodiments of the present disclosure relate to an information processing method and apparatus, a communication device, a communication system, and a storage medium. The information processing method is executed by a network device, and includes: on the basis of at least one of whether a terminal supports Network Energy Saving (NES) capability and/or the determination that the terminal triggers a service, determining at least one of whether the network device leaves a NES mode, whether to maintain the NES mode, a first duration for wake-up after leaving the NES mode, and/or a first duration for keeping the network device awake, where the terminal resides on a cell in the NES mode.

### CROSS-REFERENCE TO RELATED APPLICATIONS

The present application is a U.S. National Stage of International Application No. PCT/CN 2023/091892, filed on Apr. 28, 2023, the content of which is incorporated by reference herein in its entirety for all purposes.

### TECHNICAL FIELD

The present disclosure relates to the field of communication technologies, and in particular to information processing method and apparatus, a communication device, a communication system, and a storage medium.

### BACKGROUND

With the continuous development of wireless communication technology, various networks can realize more and more functions; network energy saving has become an important research topic.

### SUMMARY

The embodiments of the present disclosure provide information processing method and apparatus, a communication device, a communication system, and a storage medium.

According to a first aspect of the embodiments of the present disclosure, there is provided an information processing method, performed by a network device, including: determining, based on at least one of whether a terminal supports a Network Energy Saving (NES) capability or a determination that the terminal triggers a service, at least one of whether the network device exits an NES mode, whether the network device maintains the NES mode, a first duration for waking up after exiting the NES mode, or the first duration for keeping the network device awake; where the terminal resides in a cell in the NES mode.

According to a second aspect of the embodiments of the present disclosure, there is provided an information processing method, performed by a terminal, including: receiving first information, the first information indicating at least one of: whether a cell corresponding to a network device is in a Network Energy Saving NES mode; or whether the cell supports the NES mode.

According to a third aspect of the embodiments of the present disclosure, there is provided an information processing method for a communication system including a network device and a terminal; the method including: the network device, based on at least one of whether the terminal supports a Network Energy Saving NES capability or a determination that the terminal triggers a service, determines at least one of whether the network device exits NES mode, whether the network device maintains the NES mode, a first duration for waking up after exiting the NES mode, or the first duration for keeping the network device awake; and the terminal resides in a cell in the NES mode.

According to a fourth aspect of the embodiments of the present disclosure, there is provided an information processing device, including: a processing module configured to determine at least one of whether a network device exits a NES mode, whether the network device maintains the NES mode, a first duration for waking up after exiting the NES mode or the first duration for keeping the network device awake based on at least one of whether a terminal supports an NES capability or a determination that the terminal triggers a service, where the terminal resides in a cell in the NES mode.

According to a fifth aspect of the embodiments of the present disclosure, there is provided an information processing device, including: a second receiving module configured to receive first information, the first information indicating at least one of: whether a cell corresponding to a network device is in a NES mode; or whether the cell supports the NES mode.

According to a sixth aspect of the embodiments of the present disclosure, there is provided a communication device, including: one or more processors; and where the processors are configured to invoke instructions to cause the communication device to perform the information processing method according to the first aspect, the second aspect, the third aspect, or alternative implementations of the first aspect, the second aspect and the third aspect.

According to a seventh aspect of the embodiments of the present disclosure, there is provided a communications system, including: a network device and a terminal; where the network device is configured to implement the information processing method according to the alternative implementations of the first aspect, the terminal is configured to implement the information processing method according to the alternative implementations of the second aspect, and the network device is configured to implement the information processing method according to the alternative implementations of the third aspect.

According to an eighth aspect of the embodiments of the present disclosure, there is provided a storage medium storing instructions, when the instructions are executed on a communication device, the communication device executes the information processing method according to the first aspect, the second aspect, the third aspect, or alternative implementations of the first aspect, the second aspect and the third aspect.

### BRIEF DESCRIPTION OF THE DRAWINGS

To more clearly illustrate the technical solutions in the embodiments of the present disclosure, the following figures are necessary for describing the embodiments. The following figures merely illustrate some embodiments of the present disclosure and do not specifically limit the scope of protection of the present disclosure.

FIG. 1 is a schematic diagram of the structure of an information processing system according to an embodiment of the present disclosure.

FIG. 2 is an interactive diagram of an information processing method according to an embodiment of the present disclosure.

FIG. 3A is a flowchart of an information processing method according to an embodiment of the present disclosure.

FIG. 3B is a flowchart of an information processing method according to an embodiment of the present disclosure.

FIG. 3C is a flowchart of an information processing method according to an embodiment of the present disclosure.

FIG. 4A is a flowchart of an information processing method according to an embodiment of the present disclosure.

FIG. 4B is a flowchart of an information processing method according to an embodiment of the present disclosure.

FIG. 4C is a flowchart of an information processing method according to an embodiment of the present disclosure.

FIG. 5 is a flowchart of an information processing method according to an embodiment of the present disclosure.

FIG. 6A is a schematic diagram of a structure of an information processing device according to an embodiment of the present disclosure.

FIG. 6B is a schematic diagram of a structure of an information processing device according to an embodiment of the present disclosure.

FIG. 7A is a schematic diagram of a structure of a communication device provided according to an embodiment of the present disclosure.

FIG. 7B is a schematic diagram of a structure of a chip provided according to an embodiment of the present disclosure.

### DETAILED DESCRIPTION

The embodiments of the present disclosure address the problem of balancing network energy saving and normal terminal service when a cell in NES mode allows a terminal to reside.

The embodiments of the present disclosure provide information processing method and apparatus, a communication device, a communication system, and a storage medium.

In a first aspect, the embodiments of the present disclosure provide an information processing method, performed by a network device, including: determining at least one of whether the network device exits NES mode, whether the network device maintains NES mode, a first duration for waking up after the network device exiting NES mode, or a first duration for maintaining the network device awake based on at least one of whether the terminal supports an NES capability and a determination of the terminal triggers a service; the terminal resides in a cell in NES mode.

In the above embodiment, in a case where a cell in NES mode allows a terminal to reside, the network device may determine whether the network device exits NES mode and/or the duration for waking up after exiting NES mode based on at least one of whether the terminal supports an NES capability or a determination that the terminal triggers a service. This facilitates the normal operation of limited guaranteed services (or ensures normal service operation within the awake duration of the network device) and reduces the impact on normal terminal operation. This achieves a balance between network energy saving and the normal operation of limited guaranteed terminal services.

In conjunction with some embodiments of the first aspect, in some embodiments, the method includes: sending first information, the first information being configured to indicate at least one of the following: whether the cell corresponding to the network device is in NES mode; or whether the cell supports NES mode.

In the above embodiments, the network device may inform the terminal whether the cell where the network device is located is in NES mode and/or whether the cell supports NES mode, so that the terminal accurately knows whether it resides in a cell in NES mode.

In conjunction with some embodiments of the first aspect, in some embodiments, the first information includes at least one of the following: a Discontinuous Transmission (DTX) parameter, including at least one of the following: a DTX cycle, a DTX offset, and DTX monitoring time; and/or a Discontinuous Reception (DRX) parameter, including at least one of the following: a DRX cycle, a DRX offset, and DRX monitoring time.

In the above embodiments, the network device may inform the terminal whether the cell where the network device is located supports NES mode or does not support NES mode through an implicit indication.

In conjunction with some embodiments of the first aspect, in some embodiments, the method further includes receiving at least one of: message 1 (MSG1), message 3 (MSG3), or a paging message.

In the above embodiments, the network device can receive MSG1, MSG3, and paging messages sent by the terminal to facilitate determining whether the terminal triggers a service and/or supports NES capability.

In conjunction with some embodiments of the first aspect, in some embodiments, the terminal is a first terminal, and based on at least one of the terminal supporting Network Energy Saving (NES) capability or a determination that the terminal triggers a service, determining at least one of whether the network device exits NES mode, whether the network device remains in NES mode, a first duration for waking up after the network device exiting NES mode, or a first duration for keeping the network device awake includes at least one of the following: in response to determining that the first terminal has initiated a first service, determining that the network device exits NES mode; in response to determining that the first terminal has initiated the first service, determining the first duration for waking up after exiting NES mode; or in response to determining that the first terminal has initiated the first service, determining the first duration for keeping the network device awake.

In the above embodiments, the network device can determine to leave NES mode when the first terminal initiates the first service. This allows the NES mode cell to provide limited support for the first service, thereby not impacting the normal operation of the first service of the first terminal.

In conjunction with some embodiments of the first aspect, in some embodiments, the first service includes at least one of the following: an emergency call service; a high-priority service; a voice service; a video service; or an SMS service.

In the above embodiments, multiple first services (such as the emergency call service, etc.) are provided to accommodate a wide range of application scenarios.

In conjunction with some embodiments of the first aspect, in some embodiments, determining that the first terminal has initiated the first service includes at least one of the following: determining that the first terminal initiates the first service based on the preamble code of MSG1 being a first predetermined preamble code, where the first predetermined preamble code is configured to indicate waking up the network device or initiating the first service; determining that the first terminal initiates the first service based on a first predetermined bit of MSG3 being configured to indicate that the first terminal initiates the first service; or determining that the first terminal initiates the first service based on the logical channel identifier (LCID) in the media access control (MAC) subheader corresponding to MSG3 being a first predetermined value, where the first predetermined value is configured to indicate waking up the network device or initiating the first service.

In the above embodiments, determining that the first terminal has initiated the first service (e.g., an emergency call service, etc.) can be determined in a variety of ways, adapting to a wider range of application scenarios. Furthermore, existing signaling (e.g., MSG1 and/or MSG3) can be reused to indicate that the first terminal has initiated the emergency call service, reducing signaling overhead.

In conjunction with some embodiments of the first aspect, in some embodiments, the terminal is a second terminal, and based on at least one of the terminal supporting Network Energy Saving (NES) capability or a determination that the terminal triggers a service, determining at least one of whether the network device exits NES mode, whether the network device remains in NES mode, a first duration for waking up after the network device exiting NES mode, or a first duration for keeping the network device awake includes one of the following: determining to maintain NES mode based on the second terminal supporting NES capability; determining to maintain NES mode based on the second terminal supporting NES capability and a determination that the second terminal initiates a second service; determining to maintain NES mode based on the second terminal supporting NES capability and a determination that the second terminal receives a paging message; determining at least one of exiting NES mode, the first duration for waking up after exiting NES mode or the first duration for keeping the network device awake based on the second terminal supporting NES capability; determining to maintain NES mode based on the second terminal not supporting NES capability; determining at least one of exiting NES mode, the first duration for waking up after exiting NES mode, or the first duration for keeping the network device awake based on the second terminal not supporting NES capability; determining at least one of exiting NES mode, the first duration for waking up after exiting NES mode, or the first duration for keeping the network device awake based on the second terminal not supporting NES capability and determining that the second terminal initiates a second service; or determining at least one of exiting NES mode, the first duration for waking up after exiting NES mode, or the first duration for keeping the network device awake based on the second terminal not supporting NES capability and determining that the second terminal receives a paging message.

In the above embodiments, the network device can accurately determine whether to exit NES mode based on the second terminal supporting NES capability, or the network device can accurately determine whether to exit NES mode based on the second terminal supporting NES capability and determining that the second terminal has initiated a second service (or received a paging message), thereby ensuring limited service.

Furthermore, the network device can maintain NES mode upon identifying that the second terminal supports NES capability, thereby achieving energy saving. Alternatively, upon identifying that the second terminal does not support NES capability, the network device can determine to exit NES mode, thereby minimizing the impact on the normal operation of terminal services. Alternatively, upon identifying that the second terminal does not support NES capability, the network device can determine to maintain NES mode, thereby facilitating energy saving.

Furthermore, the network device can accurately determine the first duration for waking up the network device after the network device exiting NES mode, or the first duration for maintaining the network device awake, thereby facilitating normal communication between the terminal and the network device during the first duration, or facilitating normal operation of services of the network device during the first duration, etc.

In conjunction with some embodiments of the first aspect, in some embodiments, the second service includes one of the following: one or more uplink (UL) services; or a first service including at least one of the following: an emergency call service, a high-priority service, a Multimedia Emergency Service (MSC) service, a Multimedia Priority Service (MPS) service, a voice service, a video service, or a short message service (SMS) service.

In the above embodiments, multiple second services are provided to accommodate a wider range of application scenarios.

In conjunction with some embodiments of the first aspect, in some embodiments, the method includes at least one of the following: determining whether the second terminal supports NES capability based on the preamble code of MSG1 being a second predetermined preamble code, where the second predetermined preamble code is configured to indicate whether the second terminal supports NES capability; determining whether the second terminal supports NES capability based on predetermined random access channel (RACH) resources of MSG1, where the predetermined RACH resources are configured to indicate whether the second terminal supports NES capability; determining whether the second terminal supports NES capability based on the LCID in the MAC subheader corresponding to MSG3, where the LCID is a second predetermined value, and the second predetermined value is configured to indicate whether the second terminal supports NES capability; or determining whether the second terminal supports NES capability based on a second predetermined bit of MSG3, where the second predetermined bit is configured to indicate whether the second terminal supports NES capability.

In the above embodiments, the network device can indicate whether the second terminal supports NES capability in a variety of ways, adapting to a wider range of application scenarios. Furthermore, the network device can reuse existing signaling (e.g., MSG1 and/or MSG3) to indicate whether the second terminal supports NES capability, thereby reducing signaling overhead.

In conjunction with some embodiments of the first aspect, in some embodiments, the method includes: sending second information to a third terminal based on the network device exiting NES mode, the second information indicating at least one of the following: the cell deactivating NES mode; the cell deconfiguring NES mode; the cell exiting NES mode; the first duration for which the cell is awake being one or more DTX cycles; the first duration for which the network device remains awake being one or more DTX cycles; or the cell being awakened in the most recent one or more DTX cycles.

In the above embodiments, the network device may inform the third terminal in the cell that the cell deactivates NES mode and/or deconfigures NES mode and/or exits NES mode, i.e., informs the third terminal that the network device is awake, thereby facilitating normal operation of the third terminal; and/or the network device may also inform the third terminal of the first duration for which the cell is awake or the DTX cycle for which the cell is awake, thereby facilitating subsequent services of the third terminal.

In conjunction with some embodiments of the first aspect, in some embodiments, sending the first information includes one of the following: sending the first information via a system message; or sending the second information via a Radio Resource Control (RRC) signaling.

In the above-mentioned embodiments, the network device can send the first information in a variety of ways to accommodate a wider range of application scenarios. Furthermore, the network device can reuse existing signaling to send the first information, thereby reducing signaling overhead.

In conjunction with some embodiments of the first aspect, in some embodiments, sending the second information to the third terminal includes one of the following: sending the second information to the third terminal via a system message; or sending the second information to the third terminal via an RRC signaling.

In the above-mentioned embodiments, the network device can send the second information in a variety of ways to accommodate a wider range of application scenarios. Furthermore, the network device can reuse existing signaling to send the second information, thereby reducing signaling overhead.

In a second aspect, embodiments of the present disclosure provide an information processing method, performed by a terminal, including: receiving first information, the first information indicating at least one of the following: whether the cell corresponding to the network device is in NES mode; or whether the cell supports NES mode.

In conjunction with some embodiments of the second aspect, in some embodiments, the first information includes at least one of the following: a DTX parameter, including at least one of the following: a DTX cycle, a DTX offset, and DTX monitoring time; or a DRX parameter, including at least one of the following: a DRX cycle, a DRX offset, or DRX monitoring time.

In conjunction with some embodiments of the second aspect, in some embodiments, the terminal is a first terminal; and the method includes one of the following: sending MSG1, where the preamble code of MSG1 is a first predetermined preamble code; the first predetermined preamble code is configured to indicate waking up a network device or initiating an emergency call service; sending MSG3, where the first predetermined bit of MSG3 is configured to indicate that the first terminal initiates a first service; or sending MSG3, where the logical channel identifier (LCID) in the media access control (MAC) subheader corresponding to MSG3 is a first predetermined value; the first predetermined value is configured to indicate waking up the network device or initiating the first service.

In conjunction with some embodiments of the second aspect, in some embodiments, the first service includes at least one of the following: an emergency call service; a high priority service; an MSC service; an MPS service; a voice service; a video service; or an SMS service.

In conjunction with some embodiments of the second aspect, in some embodiments, the terminal is a second terminal; and the method includes one of the following: sending MSG1, where the preamble code of MSG1 is a second predetermined preamble code, and the second predetermined preamble code is configured to indicate whether the second terminal supports NES capability; sending MSG1, where the predetermined RACH resource of MSG1 is configured to indicate whether the second terminal supports NES capability; sending MSG3, where the LCID in the MAC subheader corresponding to MSG3 is a second predetermined value, and the second predetermined value is configured to indicate whether the second terminal supports NES capability; or sending MSG3, where the second predetermined bit of MSG is configured to indicate whether the second terminal supports NES capability.

In conjunction with some embodiments of the second aspect, in some embodiments, the method further includes receiving second information, and the second information is configured to indicate at least one of the following: the cell deactivating NES mode; the cell deconfiguring NES mode; the cell exiting NES mode; the first duration for which the cell is awake being one or more DTX cycles; the first duration for which the network device is kept awake being one or more DTX cycles; or the cell being awakened during the most recent one or more DTX cycles.

In conjunction with some embodiments of the second aspect, in some embodiments, receiving the first information includes one of the following: receiving the first information via a system message; or receiving the first information via an RRC signaling.

In conjunction with some embodiments of the second aspect, in some embodiments, receiving the second information includes one of the following: receiving the second information via a system message; or receiving the first information via an RRC signaling.

In a third aspect, embodiments of the present disclosure provide an information processing method for a communication system including a network device and a terminal. The method includes: the network device determines, based on at least one of whether the terminal supports a Network Energy Saving (NES) capability or a determination that the terminal triggers a service, at least one of whether the network device exits NES mode, whether the network device maintains NES mode, a first duration for waking up after the network device exiting NES mode, or a first duration for maintaining the network device awake; and the terminal resides in a cell in NES mode.

In a fourth aspect, embodiments of the present disclosure provide an information processing device, including: a processing module configured to determine, based on at least one of whether a terminal supports an NES capability or a determination that the terminal triggers a service, at least one of whether the network device exits NES mode, whether the network device remains in NES mode, a first duration for waking up after the network device exiting NES mode, or a first duration for maintaining the network device awake; and the terminal resides in a cell in NES mode.

In a fifth aspect, embodiments of the present disclosure provide an information processing device, including a second receiving module configured to receive first information, the first information indicating at least one of: whether the cell corresponding to the network device is in NES mode; or whether the cell supports NES mode.

In a sixth aspect, embodiments of the present disclosure provide a communication device, including one or more processors. Where the processors are configured to call computer instructions to cause the communication device to perform the information processing method described in the first, second, and third aspects, or any alternative implementation of the first, second, and third aspects.

In a seventh aspect, embodiments of the present disclosure provide an information processing system, including: a network device and a terminal; the network device is configured to perform the information processing method described in the alternative implementation of the first aspect, the terminal is configured to perform the information processing method described in the alternative implementation of the second aspect, and the network device is configured to perform the information processing method described in the alternative implementation of the third aspect.

In an eighth aspect, embodiments of the present disclosure provide a storage medium storing instructions that, when executed on a communication device, cause the communication device to perform the information processing method described in the first, second, and third aspects, or any alternative implementation of the first, second, and third aspects.

In a ninth aspect, embodiments of the present disclosure provide a program product that, when executed by a communication device, causes the communication device to perform the information processing method described in the first, second, and third aspects, or any alternative implementation of the first, second, and third aspects.

In a tenth aspect, embodiments of the present disclosure provide a computer program that, when executed on a computer, causes the computer to perform the information processing method described in the first, second, or third aspects, or any alternative implementation of the first, second, and third aspects.

It is understood that the first information processing device, the second information processing device, the communication device, the communication system, the storage medium, the program product, and the computer program described above are all configured to perform the methods provided by the embodiments of the present disclosure. Therefore, the beneficial effects that can be achieved can be referred to in the beneficial effects of the corresponding methods and will not be further elaborated here.

Embodiments of the present disclosure provide an information processing method and device, a communication device, a communication system, and a storage medium. In some embodiments, the terms of the information processing method and the communication method are interchangeable, the terms of the information processing device and the communication device are interchangeable, and the terms of the information processing system and the communication system are interchangeable.

The embodiments of the present disclosure are not exhaustive but merely illustrative of some embodiments and are not intended to limit the scope of protection of the present disclosure. Unless otherwise specified, each step in an embodiment can be implemented as an independent embodiment, and the steps can be combined arbitrarily. For example, a solution with some steps removed from an embodiment can also be implemented as an independent embodiment, and the order of the steps in an embodiment can be interchanged. Furthermore, alternative implementations within an embodiment can be combined arbitrarily. Furthermore, embodiments can be combined arbitrarily. For example, some or all steps from different embodiments can be combined arbitrarily, and one embodiment can be combined arbitrarily with alternative implementations from other embodiments.

In the embodiments of the present disclosure, unless otherwise specified or logically conflicting, the terminology and/or descriptions across the embodiments are consistent and mutually applicable. Technical features from different embodiments can be combined to form new embodiments based on their inherent logical relationships.

The terminology used in the embodiments of the present disclosure is for the purpose of describing specific embodiments only and is not intended to limit the present disclosure.

In the embodiments of the present disclosure, unless otherwise specified, elements in the singular, such as “a”, “an”, “the”, “above-mentioned”, “said”, “aforedescribed”, “this”, etc., can mean “one and only one”, “one or more”, “at least one”, etc. For example, when using articles like “a”, “an”, or “the” in English, the noun following the article can be understood as either singular or plural.

In the present disclosure, “multiple” refers to two or more.

In some embodiments, terms such as “at least one of”, “one or more”, “a plurality of”, and “multiple”, etc. are interchangeable.

In some embodiments, expressions such as “at least one of A or B”, “A and/or B,” “in one case A, in another case B”, and “in response to one case A, in response to another case B”, etc. may include the following technical solutions depending on the circumstances: in some embodiments, A (A is executed independently of B); in some embodiments, B (B is executed independently of A); in some embodiments, A and B are selected for execution (A and B are selectively executed); in some embodiments, A and B (both A and B are executed). The same applies when there are more branches such as A, B, and C.

In some embodiments, expressions such as “A or B”, etc. may include the following technical solutions depending on the circumstances: in some embodiments, A (A is executed independently of B); in some embodiments, B (B is executed independently of A); in some embodiments, A and B are selected for execution (A and B are selectively executed). The same applies to more branches.

The prefixes such as “first” and “second” in the embodiments of the present disclosure are only used to distinguish different description objects and do not limit the position, order, priority, quantity or content of the description objects. For the description of the description objects, please refer to the description in the context of the claims or embodiments. The use of prefixes should not constitute unnecessary restrictions. For example, if the description object is a “field”, the ordinal number before the “field” in “first field” and “second field” does not limit the position or order between the “fields”. “First” and “second” do not limit whether the “fields” they modify are in the same message, nor do they limit the order of the “first field” and “second field”. For another example, if the description object is “level”, then the ordinal number before “level” in “first level” and “second level” does not limit the priority between “levels”. For another example, the number of description objects is not limited by ordinal numbers and can be one or more. Take “first device” as an example, where the number of “device” can be one or more. In addition, the objects modified by different prefixes can be the same or different. For example, if the description object is “device”, then “first device” and “second device” can be the same device or different devices, and their types can be the same or different. For another example, if the description object is “information”, then “first information” and “second information” can be the same information or different information, and the content of the information may be the same or different.

In some embodiments, “including A,” “containing A,” “for indicating A,” and “carrying A” can be interpreted as directly carrying A or indirectly indicating A.

In some embodiments, terms such as “in response to . . . ” , “in response to determining . . . ” , “in the case of . . . ” , “at . . . ” , “when . . . ” , “if . . . ” , and so on are interchangeable.

In some embodiments, terms such as “greater than”, “greater than or equal to”, “not less than”, “more than”, “more than or equal to”, “not fewer than”, “higher than”, “higher than or equal to”, “not lower than”, and “above”, etc. are interchangeable. Terms such as “less than”, “less than or equal to”, “not greater than”, “less than”, “less than or equal to”, “not more than”, “lower than”, “lower than or equal to”, “not higher than”, and “below” are interchangeable.

In some embodiments, devices and the like can be interpreted as physical or virtual, and their names are not limited to those described in the embodiments. Terms such as “apparatus”, “equipment”, “device”, “circuit”, “network element”, “node”, “function”, “unit”, “section”, “system”, “network”, “chip”, “chip system”, “entity” and “subject” are interchangeable.

In some embodiments, the terms “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “carrier”, “component carrier”, “bandwidth part (BWP)” and the like may be used interchangeably.

In some embodiments, the terms “terminal”, “terminal device”, “user equipment (UE)”, “user terminal”, “mobile station (MS)”, “mobile terminal (MT)”, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, and client may be used interchangeably.

In some embodiments, an access network device, a core network device, or a network device may be replaced with a terminal. For example, the various embodiments of the present disclosure can also be applied to a configuration where communication between an access network device, a core network device, or a network device and a terminal is replaced with communication between multiple terminals (e.g., also referred to as device-to-device (D2D) or vehicle-to-everything (V2X)). In this case, the terminal can also have all or part of the functionality of the access network device. Furthermore, terms such as “uplink” and “downlink”, etc. can be replaced with terms corresponding to inter-terminal communication (e.g., “side”). For example, terms such as “uplink channel” and “downlink channel” can be replaced with “side channel,” and terms such as “uplink” and “downlink” can be replaced with “side link.”

In some embodiments, the terminal can be replaced with an access network device, a core network device, or a network device. In this case, the access network device, the core network device, or the network device can also have all or part of the functionality of the terminal.

In some embodiments, the names of information, etc., are not limited to those described in the embodiments. Terms such as “information”, “message”, “signal”, “signaling”, “report”, “configuration”, “indication”, “instruction”, “command”, “channel”, “parameter”, “domain”, “field”, “symbol”, “codebook”, “codeword”, “codepoint”, “bit”, “data”, “program”, and “chip” are interchangeable.

In some embodiments, terms such as “codebook”, “codeword” and “precoding matrix” are interchangeable. For example, a codebook may be a collection of one or more codewords/precoding matrices.

In some embodiments, the terms “uplink” and “physical uplink” are interchangeable. The terms “downlink” and “physical downlink” are interchangeable. The terms “side”, “sidelink”, “sidelink communication”, “direct link”, “direct connection”, “direct communication” and “direct link communication” are interchangeable.

In some embodiments, the terms “downlink control information (DCI)”, “downlink (DL) assignment”, “DL DCI”, “uplink (UL) grant”, and “UL DCI” are interchangeable.

In some embodiments, the terms “physical downlink shared channel (PDSCH)” and “DL data”, etc. are interchangeable. The terms “physical uplink shared channel (PUSCH)” and “UL data”, etc. are interchangeable.

In some embodiments, the terms “radio”, “wireless”, “radio access network (RAN)”, “access network (AN)” and “RAN-based”, etc. are interchangeable.

In some embodiments, the terms “search space”, “search space set”, “search space configuration”, “search space set configuration”, “control resource set (CORESET)” and “CORESET configuration”, etc. are interchangeable.

In some embodiments, the terms “synchronization signal (SS)”, “synchronization signal block (SSB)”, “reference signal (RS)”, “pilot” and “pilot signal”, etc. are interchangeable.

In some embodiments, the terms “timing”, “time point”, “time” and “time position”, etc. are interchangeable. The terms “duration”, “period”, “time window”, “window” and “time”, etc. are interchangeable.

In some embodiments, the terms “component carrier (CC)”, “cell”, “frequency carrier” and “carrier frequency”, etc. may be used interchangeably.

In some embodiments, the terms “resource block (RB)”, “physical resource block (PRB)”, “sub-carrier group (SCG)”, “resource element group (REG)”, “PRB pair”, “RB pair”, and “resource element (RE)”, etc. may be used interchangeably.

In some embodiments, the terms “wireless access scheme” and “waveform”, etc. may be used interchangeably.

In some embodiments, the terms “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angular degree”, “antenna”, “antenna element”, and “panel”, etc. may be used interchangeably.

In some embodiments, the terms “frame”, “radio frame”, “subframe”, “slot”, “sub-slot”, “mini-slot”, “symbol” and “transmission time interval (TTI)”, etc. are interchangeable.

In some embodiments, the terms “obtain”, “acquire”, “get”, “receive,” “transmit,” and “send and/or receive” are interchangeable and can be interpreted as meaning various things, such as receiving from another entity, obtaining from a protocol, obtaining through internal processing, or achieving autonomously.

In some embodiments, the terms “send”, “transmit”, “report”, “issue”, “transfer”, “bidirectional transmission” and “send and/or receive”, etc. are interchangeable.

In some embodiments, the terms “certain”, “predetermined”, “preset”, “set”, “indicated”, “certain”, “any” and “first”, etc. are interchangeable. “Specific A”, “particular A”, “predetermined A”, “set A”, “indicated A”, “certain A”, “any A” and “first A” may be interpreted as A pre-specified in a protocol, etc., or as A obtained through setting, configuration, or indication, or as specific A, certain A, any A, or first A, but are not limited thereto.

In some embodiments, determining may be interpreted as evaluating, deciding, judging, calculating, computing, processing, deriving, investigating, searching, looking up, searching, inquirying, ascertaining, receiving, transmitting, inputting, outputing, accessing, resolving, selecting, choosing, establishing, comparing, assuming, expecting, considering, broadcasting, notifying, communicating, forwarding, configuring, reconfiguring, allocating, mapping and assigning, but is not limited thereto.

In some embodiments, a determination or judgment may be made using a single-bit value (0 or 1) or a true or false value (Boolean) represented by true or false. This can be done by comparing values (e.g., with a predetermined value), but is not limited thereto.

In some embodiments, “network” can be interpreted as devices included in the network (e.g., an access network device, a core network device, etc.).

In some embodiments, “not expecting to receive” can be interpreted as not receiving on time domain resources and/or frequency domain resources, or as not performing subsequent processing on the data after receiving it; “not expecting to send” can be interpreted as not sending, or as sending but not expecting the recipient to respond to the content sent.

In some embodiments, obtaining data, information, etc. can be done in accordance with the laws and regulations of the local country.

In some embodiments, data, information, etc. may be obtained with the user's consent.

In addition, each element, row, or column in the table of the embodiments of the present disclosure can be implemented as an independent embodiment, and any combination of any element, row, or column can also be implemented as an independent embodiment.

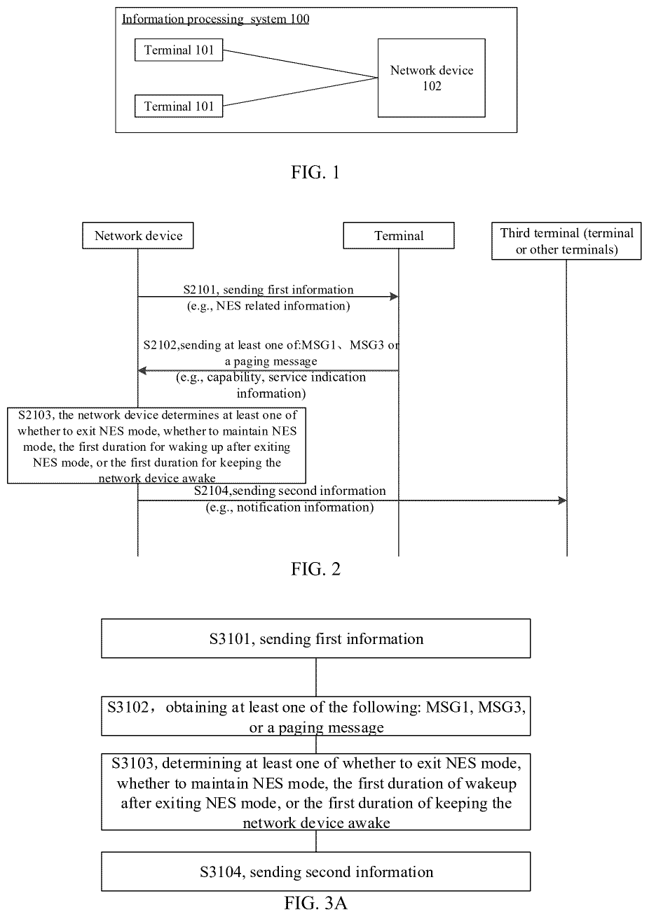

FIG. 1 is a schematic diagram of a structure of an information processing system 100 according to an embodiment of the present disclosure. As shown in FIG. 1, the information processing system 100 may include a terminal 101 and a network device 102.

In some embodiments, the network device 102 may include at least one of an access network device or a core network device, neither shown.

In some embodiments, the terminal 101 includes, for example, at least one of a mobile phone, a wearable device, an IoT device, a car with communication capability, a smart car, a pad, a computer with wireless transceiver capability, a virtual reality (VR) terminal device, an augmented reality (AR) terminal device, a wireless terminal device used in industrial control, a wireless terminal device used in self-driving, a wireless terminal device used in remote medical surgery, a wireless terminal device used in a smart grid, a wireless terminal device used in transportation safety, a wireless terminal device used in a smart city, and a wireless terminal device used in a smart home, but is not limited thereto.

In some embodiments, the access network device of the network device 102 is, for example, a node or device that connects the terminal to a wireless network. The access network device may include at least one of an evolved NodeB (eNB), a next generation NodeB (gNB), a NodeB (NB), a Home NodeB (HNB), a Home Evolved NodeB (HeNB), wireless backhaul device, a radio network controller (RNC), a base station controller (BSC), a base transceiver station (BTS), a baseband unit (BBU), a mobile switching center in a 5G communication system, a base station, an Open base station (Open RAN), a Cloud base station (Cloud RAN), a base station in other communication systems, and an access node in a Wireless Fidelity (WiFi) system, but is not limited thereto.

In some embodiments, the technical solutions of the present disclosure may be applied to an Open RAN architecture. In this case, the interfaces between or within access network devices involved in the embodiments of the present disclosure may become internal interfaces of Open RAN, and the processes and information exchange between these internal interfaces may be implemented through software or programs.

In some embodiments, the access network device of the network device 102 may be composed of a Central Unit (CU) and a Distributed Unit (DU), where the CU may also be referred to as a Control Unit (CU). The CU-DU structure can be configured to split the protocol layers of the access network device. Some protocol layer functions are centrally controlled by the CU, while some or all of the remaining protocol layer functions are distributed in the DU, which is centrally controlled by the CU, but is not limited thereto.

In some embodiments, the core network device of the network device 102 can be a single device including one or more network elements, or multiple devices or device groups each including all or part of one or more of the aforementioned network elements. The network element can be virtual or physical. The core network includes, for example, at least one of the Evolved Packet Core (EPC), the 5G Core Network (5GCN), or the Next Generation Core (NGCN).

It should be understood that the information processing system 100 described in the embodiments of the present disclosure is intended to more clearly illustrate the technical solutions of the embodiments of the present disclosure and does not constitute a limitation of the technical solutions provided by the embodiments of the present disclosure. Those skilled in the art will appreciate that, as system architectures evolve and new business scenarios emerge, the technical solutions provided by the embodiments of the present disclosure are equally applicable to similar technical problems.

The following embodiments of the present disclosure may be applied to the information processing system 100 shown in FIG. 1, or a portion thereof, but are not limited thereto. The entities shown in FIG. 1 are illustrative only. The information processing system 100 may include all or a part of the entities shown in FIG. 1, or may include entities other than those shown in FIG. 1. The number and form of the entities are arbitrary. The connections between the entities are illustrative only. The entities may be connected or disconnected, and the connections may be in any manner, whether direct or indirect, and wired or wireless.

The embodiments of the present disclosure may be applied to Long Term Evolution (LTE), LTE-Advanced (LTE-A), LTE-Beyond (LTE-B), SUPER 3G, IMT-Advanced, and 4th Generation Mobile Communication Systems (4G), 5th Generation Mobile Communication system (5G), 5G new radio (NR), Future Radio Access (FRA), New Radio Access Technology (RAT), New Radio (NR), New Radio Access (NX), Future Generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), Public Land Mobile Network (PLMN) network, Device-to-Device (D2D) system, Machine to Machine (M2M) system, Internet of Things (IOT) system, Vehicle-to-Everything (V2X) system, systems utilizing other communication methods, and next-generation systems based on these. Furthermore, multiple systems can be combined (for example, LTE or LTE-A combined with 5G, etc.).

In some embodiments, 5G base stations consume approximately four times the energy of LTE base stations, making network energy saving a key means for operators to reduce the cost of operating 5G systems.

In some embodiments, carrier aggregation (CA) is a commonly used method for exchanging bandwidth for data rate. When carriers are aggregated, multiple cells can serve a UE (e.g., a terminal). There is only one Primary Cell Component (PCC), which provides radio resource control (RRC) signaling connections, non-access stratum (NAS) functions, and/or security functions. The Physical Uplink Control Channel (PUCCH) exists on the PCC and only on the PCC. Secondary Cell Components (SCCs) only provide extra wireless resources. The PCC and SCC are collectively referred to as serving cells. Alternatively, the aggregated carriers can support 5, i.e. the maximum bandwidth after aggregation is 100 MHz, and the aggregated carriers belong to the same base station. All aggregated carriers use the same Cell Radio Network Temporary Identifier (CRNTI). The base station ensures that the C-RNTIs do not conflict in the cell where each carrier resides.

In some embodiments, the UE has no concept of carrier aggregation in idle state. In this state, the UE resides in a single cell. Alternatively, the UE initiates RRC connection setup and can add, delete, and/or modify required secondary carriers via an RRC reconfiguration message. The modification of the secondary carrier can be handled using a “delete and add” approach. Alternatively, the UE obtains system broadcast messages from the primary carrier cell on the primary carrier according to the R9 principle, while system broadcast information from the secondary carrier cell is notified via dedicated signaling (e.g., RRC reconfiguration).

In some embodiments, for the reception of the paging message, the UE only monitors paging messages on the primary carrier.

In some embodiments, to reduce network energy consumption, a network energy saving project is initiated. When the network enters energy saving mode (NES mode), cells periodically stop transmitting and/or receiving at regular intervals, i.e., cell discontinuous transmission (DTX) and/or cell discontinuous reception (DRX).

In some embodiments, the UE obtains configuration information for cell DTX and/or cell DRX configured by the network device. Alternatively, the configuration information for cell DTX and cell DRX includes a cycle, an offset, and an on-duration length.

In some embodiments, whether legacy UEs or non-NES-capable UEs need to be prohibited from residing in cells in NES mode, and if prohibited, how an emergency call is supported. For NES cells, the emergency call has a higher priority than energy saving, so the emergency call service must be supported first. Alternatively, it needs a terminal to trigger the network device to exit NES mode to support more important services, such as the emergency call service. Furthermore, once a legacy UE or non-NES-capable UE resides in a cell in NES mode, service execution should be supported.

In some embodiments, NES functions may include at least one of the following: Synchronization Signal Block-less SCell (SSB-less SCell), cell DTX and/or cell DRX, antenna port adaptation, or physical downlink shared channel (PDSCH) transmission power adaptation.

In some embodiments, if a cell prohibits other terminals from residing in or accessing it, it may do so in one of the following ways: setting barred information, then all terminals cannot reside in the cell; setting cell reserved for other uses (cellReservedForOtherUse) information, then some terminals are prohibited from accessing; or setting an intra/interFreqExcludedCellList, then terminals can be prohibited from reselecting to cells in the list.

FIG. 2 is an interactive diagram illustrating an information processing method according to an embodiment of the present disclosure. As shown in FIG. 2, the information processing method according to an embodiment of the present disclosure is used in an information processing system 100. The method includes steps S2101-S2104.

Step S2101: A network device sends first information to a terminal.

In some embodiments, the network device broadcasts the first information. Alternatively, the network device sends the first information via a system message. Alternatively, the network device sends the first information via an RRC signaling.

In some embodiments, the terminal receives the first information sent by the network device. Alternatively, the terminal may be the terminal described in the previous embodiment. Alternatively, the terminal resides in a cell in NES mode. Alternatively, the terminal is at least one of the following: a first terminal, a second terminal, or a third terminal. Alternatively, the terminal is a terminal initiating an emergency call service. Alternatively, the terminal is a terminal initiating a service; the service is any type of service. Alternatively, the terminal is at least one of the following: a legacy terminal, a non-NES capable terminal, or an NES capable terminal.

Alternatively, the terminal receives the first information sent by the network device via the system message. Alternatively, the terminal receives the first information sent by the network device via the RRC signaling.

In some embodiments, the name of the first information is not limited and may be, for example, NES-related information, etc.

In some embodiments, the first information is configured to indicate at least one of the following: whether the cell corresponding to the network device is in NES mode or whether the cell corresponding to the network device supports NES mode.

In some embodiments, the first information includes at least one of the following: first indication information or second indication information. Alternatively, the first indication information is configured to indicate that the cell is in NES mode or not in NES mode; the second indication information is configured to indicate that the cell supports NES mode or does not support NES mode. Alternatively, the first indication information is configured to indicate that the cell is not in NES mode, i.e., the first indication information is configured to indicate that the cell is in non-NES mode; the second indication information is configured to indicate that the cell does not support NES mode.

For example, the first indication information has a first value, indicating that the cell is in NES mode; or, the first indication information has a second value, indicating that the cell is not in NES mode. Both the first value and the second value can be one or more bits.

For example, the second indication information has a third value, indicating that the cell supports NES mode; or, the second indication information has a fourth value, indicating that the cell does not support NES mode.

Alternatively, the names of the first indication information and the second indication information are not limited, and can be, for example, display indication information, etc.

In some embodiments, the first information includes at least one of the following: a DTX parameter or a DRX parameter. Alternatively, the first information includes a DTX parameter, indicating that the cell is in NES mode and/or supports NES mode; or, the first information does not include the DTX parameter, indicating that the cell is not in NES mode and/or does not support NES mode. Alternatively, the first information includes a DRX parameter, indicating that the cell is in NES mode and/or supports NES mode; or, the first information does not include the first information, indicating that the cell is not in NES mode and/or does not support NES mode.

In some embodiments, the DTX parameter includes at least one of the following: a DTX cycle, a DTX offset, or a DTX on-duration; and the DRX parameter includes at least one of the following: a DRX cycle, a DRX offset, or DRX monitoring time. Alternatively, the monitoring time is the on-duration length.

Alternatively, the names of the DTX parameter and/or DRX parameter are not limited and may be, for example, NES-related parameters, etc. The DTX parameter and/or DRX parameter carried in the first information may be implicitly indicated.

In step S2102, the terminal sends at least one of the following to the network device: MSG1, MSG3, or a paging message.

In some embodiments, whether the terminal supports NES capability may not be indicated by MSG1 and/or MSG3, or the terminal may not be instructed to initiate a service by MSG1 and/or MSG3. Instead, third information, such as capability or service indication information etc., may be used to indicate whether the terminal supports NES capability and/or to instruct the terminal to initiate a service.

In some embodiments, a first terminal sends MSG1 to the network device. Alternatively, MSG1 may be MSG1 during a four-step random access process or MSGA during a two-step random access process. Alternatively, the first terminal is resident in a cell in NES mode. Alternatively, the first terminal is a terminal initiating an emergency paging service. Alternatively, the first terminal is at least one of the following: a legacy terminal, a non-NES-capable terminal, or an NES-capable terminal.

In some embodiments, the network device receives MSG1 sent by the first terminal. Alternatively, the preamble code of MSG1 is a first predetermined preamble code; the first predetermined preamble code is configured to indicate waking up a network device or initiating a first service. Alternatively, the first predetermined preamble code is a preamble code reserved for waking up a network device or initiating an emergency service. Here, it can be determined that the first terminal initiates the first service.

Alternatively, the first service includes at least one of the following: an emergency call service, a high-priority service, a first-priority service, an MSC service, an MPS service, a voice service, a video service, or an SMS service. For example, a first-priority service has a higher priority than a second-priority service.

Alternatively, the first service includes at least one of the following: an emergency service (emergency), a high priority access service (highPriorityAccess), a mobile terminated access service (mt-Access), a mobile originated signaling service (mo-Signalling), a mobile originated data service (mo-Data), a mobile originated voice call service (mo-VoiceCall), a mobile originated video call service (mo-VideoCall), a mobile originated short message service (mo-SMS), a radio access network notification area update service (rna-Update), a multimedia priority access service (mps-PriorityAccess), or a multimedia emergency access service (mcs-PriorityAccess).

In some embodiments, the first terminal sends MSG3 to the network device. Alternatively, MSG3 is MSG3 in the four-step random access process.

In some embodiments, the network device receives MSG3 sent by the first terminal.

Alternatively, the first predetermined bit of MSG3 is configured to indicate that the first terminal is in an emergency situation. This can be used to determine that the first terminal has initiated an emergency call service.

Alternatively, the first predetermined bit of MSG3 is configured to indicate that the first terminal has initiated the first service.

For example, the first predetermined bit is one of the following: a cause value, a reserved bit, and a predefined bit. Alternatively, the predefined bit may be any predefined bit in MSG3. Alternatively, the cause value of MSG3 may be “emergency.”

Alternatively, the LCID in the MAC subheader corresponding to MSG3 is a first predetermined value. The first predetermined value is configured to indicate waking up the network device or initiating the first service. Here, it can be determined that the first terminal has initiated the first service.

For example, the first predetermined value is one or more bits.

For example, the MAC subheader corresponding to MSG3 is the MAC subheader corresponding to the service data unit (SUD) of MSG3 in the transport block (TB) containing MSG3. For example, the MAC subheader is the MAC packet header.

In some embodiments, the second terminal sends MSG1 to the network device. Alternatively, MSG1 may be MSG1 in a four-step random access procedure or MSGA in a two-step random access procedure.

Alternatively, the second terminal resides in a cell in NES mode. Alternatively, the second terminal is a terminal initiating an emergency paging service. Alternatively, the second terminal is at least one of the following: a legacy terminal, a non-NES-capable terminal, or an NES-capable terminal

Alternatively, the second terminal is the same as the first terminal. Alternatively, the third terminal is different from the first terminal.

In some embodiments, the network device receives MSG1 sent by the second terminal.

Alternatively, the preamble code of MSG1 is a second predetermined preamble code. The second predetermined preamble code is configured to indicate whether the second terminal supports NES capability.

Alternatively, a predetermined RACH resource of MSG1 is configured to indicate whether the second terminal supports NES capability. For example, the predetermined RACH resource is any RACH resource of MSG1.

In some embodiments, the second terminal sends MSG3 to the network device. Alternatively, MSG3 is MSG3 in the four-step random access procedure.

In some embodiments, the network device receives MSG3 sent by the second terminal.

Alternatively, the LCID in the MAC subheader corresponding to MSG3 is a second predetermined value, and the second predetermined value is configured to indicate whether the second terminal supports NES capability.

For example, the second predetermined value is one or more bits. For example, the second predetermined value is a first value, and the first value is configured to indicate that the second terminal supports NES capability; or, the second predetermined value is a second value, and the second value is configured to indicate that the third terminal does not support NES capability.

Alternatively, the second predetermined bit of MSG3 is configured to indicate whether the second terminal supports NES capability.

For example, the first predetermined bit is one of the following: a reserved bit and a predefined bit. Alternatively, the predefined bit can be any predefined bit in MSG3.

In some embodiments, the second terminal sends a paging message to the network device. Alternatively, the paging message is configured to determine at least one of whether to exit NES mode, whether to maintains NES mode, the first duration for waking up after the exiting NES mode, or the first duration for keeping the network device awake.

In some embodiments, the network device receives a paging message sent by a second terminal.

In step S2103, the network device determines at least one of whether to exit NES mode, whether to maintain NES mode, the first duration for waking up after exiting NES mode, or the first duration for keeping the network device awake.

Alternatively, the network device determines at least one of whether to exit NES mode, whether to maintain NES mode, the first duration for waking up after exiting NES mode, or the first duration for keeping the network device awake based on at least one of the terminal supporting NES capability or a determination that the terminal triggers a service.

Alternatively, the network device determines a first operation of whether the network device exits NES mode based on at least one of the terminal supporting NES or a determination that the terminal triggers a service. Alternatively, the first operation includes at least one of: determining to exit NES mode, determining not to exit NES mode, determining to maintain NES mode, or determining not to maintain NES mode.

Alternatively, the network device determines the duration for which the network device is awake based on at least one of the terminal supporting NES capability or a determination that the terminal triggers a service. Alternatively, determining that the network device is awake includes at least one of: determining a first duration for the network device to be awakened after exiting NES mode, or determining a first duration for the network device to remain awake.

For example, the network device may determine a first duration for the network device to be awakened or for the network device to remain awake.

For example, the network device may determine a first duration for the cell corresponding to the network device to be awakened or for the cell to remain awake.

For example, determining the first duration for the network device to be awakened after exiting NES mode is determining the first duration for the network device to remain awake.

For example, the first duration is any duration. For example, the first duration is one or more DTX cycles. Alternatively, the DTX cycle is a cell DTX cycle.

Alternatively, whether the terminal supports the NES capability includes the terminal supporting the NES capability or the terminal not supporting the NES capability.

Alternatively, determining that the terminal triggers a service includes one of the following: determining that the terminal initiates an emergency call service, determining that the terminal initiates a first service, determining that the terminal initiates a second service, and determining that the terminal receives a paging message.

For example, the second service is any service. For example, the second service can be any one or more UL services; in another example, the second service can be the first service.

In some embodiments, the network device determines to exit NES mode based on determining that the first terminal initiates the first service.

Alternatively, the network device determines that the first terminal initiates the first service based on MSG1 and/or MSG3.

For example, if the network device determines that the preamble code of MSG1 is a first predetermined preamble code, the network device determines that the first terminal initiates the emergency call service.

For example, if the network device determines that the first predetermined bit of MSG3 is configured to indicate that the first terminal initiates the first service, the network device determines that the first terminal initiates the first service.

For example, if the network device determines that the cause value of MSG3 indicates that the first terminal is in an emergency situation or the cause value of MSG3 is “emergency”, the network device determines that the first terminal initiates the emergency call service.

For example, if the network device determines that the LCID in the MAC subheader corresponding to MSG3 is a first predetermined value, the network device determines that the first terminal initiates an emergency call service.

In some embodiments, based on determining that the first terminal initiates the first service, the network device determines a first duration for waking up after exiting NES mode.

For example, the network device determines that the first duration for waking up after exiting NES mode is an arbitrary duration, or one or more DTX cycles.

In some embodiments, based on determining that the first terminal initiates the first service, the network device determines a first duration for maintaining the network device awake.

For example, the network device determines that the first duration for maintaining the network device awake can be an arbitrary duration, or one or more DTX cycles.

For example, the network device may determine the first duration based on the duration of the first service.

In some embodiments, the network device determines to maintain NES mode based on the second terminal supporting NES capability. Alternatively, the network device may also determine one of the following: the second terminal initiates the second service, the second terminal does not initiate the second service, the second terminal receives a paging message, or the second terminal does not receive a paging message.

In some embodiments, the network device determines to maintain NES mode based on the second terminal supporting NES capability and determining that the second terminal initiates a second service.

In some embodiments, the network device determines to maintain NES mode based on the second terminal supporting NES capability and determining that the second terminal receives a paging message.

In some embodiments, the network device determines at least one of exiting NES mode, a first duration for waking up after exiting NES mode, or a first duration for maintaining the network device awake based on the second terminal supporting NES capability. Alternatively, the network device may also determine one of the following: the second terminal initiates the second service, and the second terminal receives a paging message.

In some embodiments, the network device determines to maintain NES mode based on the second terminal not supporting NES capability. Alternatively, the network device may also determine one of the following: the second terminal does not initiate the second service, and the second terminal does not receive a paging message.

In some embodiments, the network device determines at least one of exiting NES mode, a first duration for waking up after exiting NES mode, or a first duration for maintaining the network device awake based on the second terminal not supporting NES capability. Alternatively, the network device may also determine one of the following: the second terminal initiating the second service, the second terminal not initiating the second service, the second terminal receiving a paging message, and the second terminal not receiving a paging message.

In some embodiments, based on the second terminal not supporting NES capability and determining that the second terminal initiates the second service, the network device determines at least one of exiting NES mode, a first duration for waking up after exiting NES mode, or a first duration for keeping the network device awake.

In some embodiments, based on the second terminal not supporting NES capability and determining that the second terminal receives a paging message, the network device determines at least one of exiting NES mode, a first duration for waking up after exiting NES mode, or a first duration for keeping the network device awake.

Alternatively, the network device determines whether the second terminal supports NES capability based on MSG1 and/or MSG3.

Alternatively, the network device determines whether the second terminal supports NES capability based on the preamble code of MSG1 being a second predetermined preamble code. For example, if the network device determines that the second predetermined preamble code of MSG1 indicates that the second terminal supports NES capability, the network device determines that the second terminal supports NES capability; or, if the network device determines that the second predetermined preamble code of MSG1 indicates that the second terminal does not support NES capability, the network device determines that the second terminal does not support NES capability.

Alternatively, the network device determines whether the second terminal supports NES capability based on the predetermined RACH resources of MSG1. For example, if the network device determines that the predetermined RACH resources of MSG1 indicate that the second terminal supports NES capability, the network device determines that the second terminal supports NES capability; or, if the network device determines that the predetermined RACH resources of MSG1 indicate that the second terminal does not support NES capability, the network device determines that the second terminal does not support NES capability.

Alternatively, the network device determines whether the second terminal supports NES capability based on the LCID of MSG3. For example, if the network device determines that the second predetermined value in the LCID of MSG3 indicates that the second terminal supports NES capability, the network device determines that the second terminal supports NES capability; or, if the network device determines that the second predetermined value in the LCID of MSG3 indicates that the second terminal does not support NES capability, the network device determines that the second terminal does not support NES capability.

Alternatively, the network device determines whether the second terminal supports NES capability based on the second predetermined bit of MSG3. For example, if the network device determines that the second predetermined bit of MSG3 indicates that the second terminal supports NES capability, the network device determines that the second terminal supports NES capability; or, if the network device determines that the second predetermined bit of MSG3 indicates that the second terminal does not support NES capability, the network device determines that the second terminal does not support NES capability.

Alternatively, the network device may determine whether the terminal supports NES capability based on pre-stored terminal information and/or terminal capability information, etc.

Step S2104: The network device sends the second information to the third terminal.

Alternatively, the third terminal is a terminal other than the first terminal residing in a cell in NES mode; the third terminal is different from the first terminal. That is, the third terminal is another terminal.

Alternatively, the third terminal is the same as the first terminal.

Alternatively, the third terminal is a terminal other than the second terminal residing in a cell in NES mode; the third terminal is different from the second terminal. That is, the third terminal is another terminal.

Alternatively, the third terminal is the same as the second terminal.

Alternatively, the network device sends the second information to the third terminal via a system message. Alternatively, the network device sends the second information to the third terminal via an RRC signaling.

In some embodiments, the third terminal receives the second information sent by the network device.

Alternatively, the third terminal receives the second information sent by the network device via a system message. Alternatively, the third terminal receives the second information sent by the network device via an RRC signaling. Alternatively, the third terminal is a terminal other than the first terminal or the second terminal; or, the third terminal is the first terminal or the second terminal.

Alternatively, the second information is used for at least one of the following: the cell deactivating NES mode, the cell deconfiguring NES mode, the cell exiting NES mode, the first duration of the cell being awakened being one or more DTX cycles, or the cell being awakened in the last one or more DTX cycles.

For example, the most recent one or more DTX cycles of the cell may be the most recent one or more DTX cycles after the cell was awakened.

For example, the second information is configured to inform the third terminal of at least one of the following: the cell corresponding to the network device deactivating NES mode, the cell corresponding to the network device deconfigurating NES mode, the cell corresponding to the network device (i.e., the network device) exiting NES mode, one or more DTX cycles during which the network device was awakened, or one or more DTX cycles during which the network device was awakened.

Alternatively, the name of the second information is not limited and may be, for example, notification information, deactivation information, or deconfiguration information, etc.

Alternatively, after receiving MSG1 and/or MSG3 sent by the first terminal, the network device sends the second information to the third terminal.

The information processing method according to the embodiments of the present disclosure may include at least one of steps S2101 to S2104. For example, step S2101 can be implemented as an independent embodiment; step S2102 can be implemented as an independent embodiment; step S2103 can be implemented as an independent embodiment; the combination of step S2101 and step S2103 can be implemented as an independent embodiment; the combination of step S2102 and step S2103 can be implemented as an independent embodiment; the combination of step S2103 and step S2104 can be implemented as an independent embodiment; and the combination of step S2101, step S2103, and step S2104 can be implemented as an independent embodiment; but the present disclosure is not limited thereto.

In some embodiments, step S2102 can be omitted.

In some embodiments, step S2101 and step S2103 can be swapped in order or performed simultaneously.

In some embodiments, step S2101, step S2102, and step S2104 are optional, and one or more of these steps may be omitted or replaced in different embodiments.

In some embodiments, steps S2103, S2103, and S2104 may be optional, and one or more of these steps may be omitted or replaced in different embodiments.

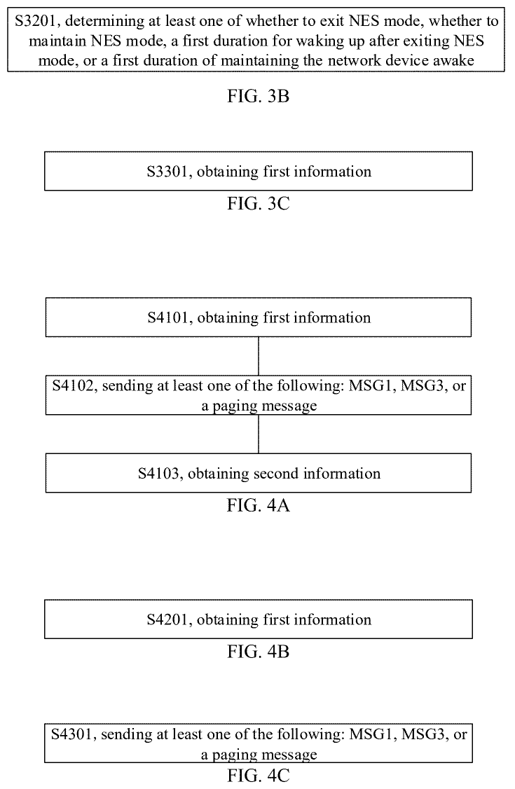

FIG. 3A is a flowchart illustrating an information processing method according to an embodiment of the present disclosure. As shown in FIG. 3A, the embodiment of the present disclosure relates to an information processing method, which is performed by a network device and includes steps S3101-S3104.

Step S3101: Sending first information.

Alternative implementation(s) of step S3101 can be found in the alternative implementation(s) of step S2101 in FIG. 2 and other related portions of the embodiment involved in FIG. 2, and are not further described here.

In some embodiments, the network device may send the first information via a system message. In some embodiments, the network device may send the first information via an RRC signaling. In some embodiments, the network device may send the first information via a paging message. In some embodiments, the network device sends the first information to the terminal, but this is not limited to this and the network device may also send the first information to other entities.

Alternatively, the first information is used by the terminal to determine whether the cell corresponding to the network device is in NES mode and/or the first information is used by the terminal to determine whether the network device supports NES mode.

Step S3102: Obtaining at least one of the following: MSG1, MSG3, or a paging message.

Alternative implementation(s) of step S3102 can be found in the alternative implementation(s) of step S2102 in FIG. 2 and other related portions of the embodiment involved in FIG. 2 and are not further described here.

In some embodiments, the network device receives MSG1 and/or MSG3 sent by the terminal, but is not limited thereto and the network device may also receive MSG1 and/or MSG3 sent by other entities.

In some embodiments, the network device may not determine whether the terminal supports NES capability and/or the terminal triggers a service based on MSG1 and/or MSG3; instead, the network device determines whether the terminal supports NES capability and/or the terminal triggers a service based on third information. Alternatively, the third information is configured to instruct the first terminal to trigger an emergency call service. Alternatively, the third information is configured to indicate whether the second terminal supports NES capability.

Alternatively, the network device obtains the third information specified by the protocol. Alternatively, the network device obtains the third information from an upper layer(s). Alternatively, the network device processes to obtain the third information.

In some embodiments, step S3102 is omitted, and the terminal autonomously implements the function indicated by the first information, or the function is default.

Step S3103: Determining at least one of whether to exit NES mode, whether to maintain NES mode, the first duration of wakeup after exiting NES mode, or the first duration of keeping the network device awake.

In some embodiments, the network device determines at least one of whether to exit NES mode, whether to maintain NES mode, the first duration of wakeup after exiting NES mode, or the first duration of keeping the network device awake based on at least one of whether the terminal supports an NES capability or a determination that the terminal triggers a service.

In some embodiments, the network device determines a first operation of whether the network device exits NES mode. The first operation includes at least one of: determining whether to exit NES mode or whether to maintain NES mode.

In some embodiments, the network device determines the duration for which the network device is awake. Determining the duration for which the network device is awake includes at least one of: determining the first duration for which the network device is awake after exiting NES mode or determining the first duration of keeping the network device awake.

Alternative implementation(s) of step S3103 can be found in the alternative implementation(s) of step S2103 in FIG. 2 and other related portions of the embodiment involved in FIG. 2, and are not further described here.

In some embodiments, whether the terminal supports the NES capability is determined based on MSG1 or MSG3. In some embodiments, whether the terminal triggers a service is determined based on MSG1 or MSG3.

In some embodiments, before step S3103, the method may further include: the network device receives MSG1 and/or MSG3 sent by the terminal. Alternatively, the terminal sends MSG1 and/or MSG3 to the network device.

Step S3104: Sending second information.

Alternative implementations of step S3104 can be found in the alternative implementation(s) of step S2104 in FIG. 2 and other related portions of the embodiment involved in FIG. 2, and are not further described here.

In some embodiments, the network device may send the second information via a system message. In some embodiments, the network device may send the second information via an RRC signaling. In some embodiments, the network device may send the second information via a paging message. In some embodiments, the network device sends the second information to a terminal, but is not limited thereto. The network device may also send the second information to other entities. Alternatively, the terminal may include a first terminal, a second terminal, or other terminals other than the first or second terminal. Alternatively, the terminal may include a third terminal. The third terminal may be the same as the first terminal, or the third terminal may be the same as the second terminal, or the third terminal may be different from the first and second terminals.

Alternatively, the second information is configured to inform the third terminal of one of the following: the cell corresponding to the network device deactivating NES mode; the cell corresponding to the network device deconfigurating NES mode; the cell (i.e., the network device) corresponding to the network device exiting NES mode; the first duration of the network device being awakened after exiting NES mode being one or more DTX cycles; the first duration of the network device being awake being one or more DTX cycles; or the network device being awakened in the most recent one or more DTX cycles.

The information processing method according to the embodiments of the present disclosure may include at least one of steps S3101 to S3104. For example, step S3101 can be implemented as an independent embodiment; step S3102 can be implemented as an independent embodiment; step S3103 can be implemented as an independent embodiment; the combination of step S3101 and step S3103 can be implemented as an independent embodiment; the combination of step S3102 and step S3103 can be implemented as an independent embodiment; the combination of step S3103 and step S3104 can be implemented as an independent embodiment; and the combination of step S3101, step S3103, and step S3104 can be implemented as an independent embodiment; but the present disclosure is not limited thereto.

In some embodiments, step S3101 and step S3103 can be swapped in order or performed simultaneously.

In some embodiments, step S3102 can be omitted.

In some embodiments, step S3101, step S3102, and step S3104 are optional, and one or more of these steps may be omitted or replaced in different embodiments.

In some embodiments, steps S3102, S3103, and S3104 may be optional, and one or more of these steps may be omitted or replaced in different embodiments.

FIG. 3B is a flowchart illustrating an information processing method according to an embodiment of the present disclosure. As shown in FIG. 3B, the embodiment of the present disclosure relates to an information processing method performed by a network device. The method includes step S3201.

Step S3201: determining at least one of whether to exit NES mode, whether to maintain NES mode, a first duration for waking up after exiting NES mode, or a first duration of maintaining the network device awake.

Alternative implementation(s) of step S3201 may be found in alternative implementations in step S2103 in FIG. 2 or in step S3103 in FIG. 3A, as well as other related portions of the embodiments related to FIG. 2 and FIG. 3A, and are not further described here.

In some embodiments, the network device determines at least one of whether to exit NES mode, whether to maintain NES mode, a first duration for waking up after exiting NES mode, or a first duration for maintaining the network device awake based on at least one of whether the terminal supports an NES capability or a determination that the terminal triggers a service.

Alternatively, the network device determines whether to exit NES mode based on whether the terminal supports NES capability. Alternatively, the network device determines whether to exit NES mode based on whether the terminal supports NES capability and a determination that the terminal triggers a service. Alternatively, the network device determines whether to exit NES mode based on the terminal triggering a service.

In some embodiments, the method includes transmitting first information, the first information indicating at least one of whether the cell corresponding to the network device is in NES mode, or whether the cell corresponding to the network device supports NES mode.

In some embodiments, the first information includes at least one of the following: first indication information indicating the cell is in NES mode or the cell is not in NES mode; and second indication information indicating the cell supports NES mode or the cell does not support NES mode.

In some embodiments, the first information includes at least one of the following: a DTX parameter, including a DTX cycle, a DTX offset, and/or DTX monitoring time; and a DRX parameter, including a DRX cycle, a DRX offset, and/or DRX monitoring time.

In some embodiments, the terminal is a first terminal, and determining the network device whether to exit NES mode, whether to maintain NES mode, a first duration for waking up after exiting NES mode, and a first duration for keeping the network device awake based on at least one of whether the terminal supports a Network Energy Saving (NES) capability or a determination that the terminal triggers a service, includes at least one of the following: determining to exit NES mode based on determining that the first terminal initiates a first service; determining the first duration for waking up after exiting NES mode based on determining that the first terminal initiates the first service; or determining the first duration for keeping the network device awake based on determining that the first terminal has initiated the first service.

In some embodiments, the first service includes at least one of the following: an emergency call service, a high-priority service, a first-priority service, a voice service, a video service, or a text message service. Alternatively, the priority of the first-priority service is higher than the priority of the second-priority service.

In some embodiments, determining that the first terminal has initiated the first service includes at least one of the following: determining that the first terminal has initiated the first service based on the preamble code of MSG1 being a first predetermined preamble code; the first predetermined preamble code being configured to indicate waking up a network device or initiating the first service; determining that the first terminal has initiated the first service based on the first predetermined bit of MSG3 being configured to indicate that the first terminal has initiated the first service; or determining that the first terminal has initiated the first service based on the LCID in the MAC subheader corresponding to MSG3 being a first predetermined value; the first predetermined value being configured to indicate waking up the network device or initiating the first service.

In some embodiments, the terminal is a second terminal, and the determining the network device whether to exit NES mode, whether to maintain NES mode, a first duration for waking up after exiting NES mode, and a first duration for keeping the network device awake, based on at least one of whether the terminal supports a Network Energy Saving (NES) capability or a determination that the terminal triggers a service, includes at least one of the following: determining to maintain NES mode based on the second terminal supporting NES capability; determining to maintain NES mode based on the second terminal supporting NES capability and a determination that the second terminal has initiated a second service; determining to maintain NES mode based on the second terminal supporting NES capability and a determination that the second terminal has received a paging message; determining at least one of exiting NES mode, the first duration for waking up after exiting NES mode, or the first duration for keeping the network device awake, based on the second terminal supporting NES capability; determining to maintain NES mode based on the second terminal not supporting NES capability; determining at least one of exiting NES mode, a first duration for waking up after exiting NES mode, or a first duration for keeping the network device awake based on the second terminal not supporting NES capability; determining at least one of exiting NES mode, a first duration for waking up after exiting NES mode, or a first duration for keeping the network device awake based on the second terminal not supporting NES capability or determining that the second terminal has initiated a second service; or determining at least one of exiting NES mode, a first duration for waking up after exiting NES mode, or a first duration for keeping the network device awake based on the second terminal not supporting NES capability or determining that the second terminal has received a paging message.

In some embodiments, the second service includes one one or more uplink services.

The first service includes at least one of the following: an emergency call service, a high-priority service, a first-priority service, an MSC service, an MPS service, a voice service, a video service, or an SMS service. The first-priority service has a higher priority than the second-priority service.

In some embodiments, the method includes at least one of the following: determining whether the second terminal supports NES capability based on a preamble code of MSG1 being a second predetermined preamble code, where the second predetermined preamble code is configured to indicate whether the second terminal supports NES capability; determining whether the second terminal supports NES capability based on a predetermined RACH resource of MSG1, where the predetermined RACH resource is configured to indicate whether the second terminal supports NES capability; determining whether the second terminal supports NES capability based on an LCID in a MAC subheader corresponding to MSG3, where the LCID is a second predetermined value, and the second predetermined value is configured to indicate whether the third terminal supports NES capability; or determining whether the second terminal supports NES capability based on a second predetermined bit of MSG3, where the second predetermined bit is configured to indicate whether the second terminal supports NES capability.

In some embodiments, the method includes, based on the network device exiting NES mode, sending second information to a third terminal, and the second information indicates at least one of the following: the cell deactivating NES mode; the cell deconfiguring NES mode; the cell exiting NES mode; the first duration for which the cell is awake is at least one DTX cycle; the first duration for which the network device remains awake is one or more DTX cycles; or the cell being awakened in the most recent one or more DTX cycles.

In some embodiments, sending the first information includes one of the following: sending the first information via a system message; or sending the second information via an RRC signaling.

In some embodiments, sending the second information to the third terminal includes one of the following: sending the second information to the third terminal via a system message; or sending the second information to the third terminal via an RRC signaling.

The above embodiments may be implemented individually or in combination. Alternative implementations may be found in the alternative implementations of the steps in FIG. 2 and FIG. 3A and are not further described here.

FIG. 3C is a flow chart illustrating an information processing method according to an embodiment of the present disclosure. As shown in FIG. 3C, an embodiment of the present disclosure relates to an information processing method, performed by a network device. The method includes step S3301.

Step S3301: sending first information.

Alternative implementation(s) of step S3301 may refer to the alternative implementations of step S2101 in FIG. 2, or step S3101 in FIG. 3A, and other related portions of the embodiments described in FIG. 2 and FIG. 3A, and are not described in detail here.

FIG. 4A is a flow chart illustrating an information processing method according to an embodiment of the present disclosure. As shown in FIG. 4A, an embodiment of the present disclosure relates to an information processing method, performed by a terminal. The method includes steps S4101-S4103.

Step S4101: obtaining first information.

Alternative implementation(s) of step S4101 may refer to the alternative implementation of step S2101 in FIG. 2, and other related portions of the embodiments described in FIG. 2, and are not described in detail here.

In some embodiments, the terminal receives first information sent by the network device, but is not limited thereto. The terminal can also receive first information sent by other entities. In some embodiments, the terminal obtains first information specified by a protocol. In some embodiments, the terminal obtains the first information from an upper layer(s). In some embodiments, the terminal processes to obtain the first information.

In some embodiments, step S4101 is omitted, and the terminal autonomously implements the function indicated by the first information, or the function is defaulted.

In some embodiments, the terminal receives the first information via a system message. In some embodiments, the terminal sends the first information via an RRC signaling. In some embodiments, the terminal receives the first information via a paging message.

In step S4102, at least one of the following is sent: MSG3, MSG1, or a paging message.

Alternative implementation(s) of step S4102 can refer to the alternative implementation(s) of step S2102 in FIG. 2 and other related portions of the embodiment involved in FIG. 2 and are not further described here.

In some embodiments, the terminal sends MSG3 and/or MSG1 to the network device, but is not limited thereto. MSG3 and/or MSG1 may also be sent to other entities.

In some embodiments, the terminal is a first terminal; the first terminal sends MSG3 and/or MSG1 to the network device. MSG3 and/or MSG1 are used by the network device to determine that the terminal has initiated an emergency call service. Alternatively, the cause value of MSG3, the LCID in the MAC subheader corresponding to MSG3, and/or the first predetermined preamble code of MSG1 are used by the network device to determine that the terminal has initiated an emergency call service.

In some embodiments, the terminal is a second terminal; the second terminal sends MSG3 and/or MSG1 to the network device. MSG3 and/or MSG1 are used by the network device to determine whether the terminal supports NES capability. Alternatively, the second predetermined preamble code of MSG1 and/or the LCID in the MAC subheader corresponding to MSG3 are used by the network device to determine whether the terminal supports NES capability.

Step S4103: obtaining second information.

Alternatively, the second information is sent by the network device after it determines to exit NES mode.

Alternative implementation(s) of step S4103 can be found in the alternative implementation(s) of step S2104 in FIG. 2 and other related portions of the embodiment involved in FIG. 2 and are not further described here.

In some embodiments, the terminal receives second information sent by the network device, but is not limited thereto. The terminal may also receive second information sent by other entities. In some embodiments, the terminal obtains second information specified by a protocol. In some embodiments, the terminal obtains the second information from an upper layer(s). In some embodiments, the terminal processes to obtain the second information.

In some embodiments, step S4103 is omitted, the terminal autonomously implements the function indicated by the second information, or the function is defaulted.

In some embodiments, the terminal receives the second information via a system message. In some embodiments, the terminal sends the second information via an RRC signaling. In some embodiments, the terminal receives the second information via a paging message.

The information processing method according to the embodiments of the present disclosure may include at least one of steps S4101 to S4103. For example, step S4101 may be implemented as an independent embodiment. Step S4102 can be implemented as an independent embodiment; the combination of step S4101 and step S4102 can be implemented as an independent embodiment; the combination of step S4101 and step S4103 can be implemented as an independent embodiment; the combination of step S4102 and step S4103 can be implemented as an independent embodiment; and the combination of step S4101, step S4102, and step S4103 can be implemented as an independent embodiment, but are not limited thereto.

In some embodiments, step S4101 and step S4103 are optional, and one or more of these steps may be omitted or replaced in different embodiments.

In some embodiments, step S4102 and step S4103 are optional, and one or more of these steps may be omitted or replaced in different embodiments.

FIG. 4B is a flowchart illustrating an information processing method according to an embodiment of the present disclosure. As shown in FIG. 4B, the embodiment of the present disclosure relates to an information processing method performed by a terminal, including step S24201.

Step S4201: obtaining first information.

Alternative implementation(s) of step S3201 can be found in the alternative implementations of step S2101 in FIG. 2 or step S4102 in FIG. 4A, as well as other related portions of the embodiments involved in FIG. 2 and FIG. 3A, and are not further described here.

In some embodiments, the first information is configured to indicate at least one of the following: whether the cell corresponding to the network device is in network energy saving (NES) mode; or whether the cell corresponding to the network device supports NES mode.

In some embodiments, the first information includes at least one of the following: first indication information indicating the cell is in NES mode or the cell is not in NES mode; or second indication information indicating the cell supports NES mode or the cell does not support NES mode.

In some embodiments, the first information includes at least one of the following: a DTX parameter, including at least one of the following: a DTX cycle, a DTX offset, and DTX monitoring time; or a DRX parameter, including at least one of the following: a DRX cycle, a DRX offset, or DRX monitoring time.

In some embodiments, the terminal is a first terminal; the method includes one of the following: sending MSG1, where the preamble code of MSG1 is a first predetermined preamble code; the first predetermined preamble code is configured to indicate waking up the network device or initiating an emergency call service; sending MSG3, where the first predetermined bit of MSG3 is configured to indicate that the first terminal has initiated a first service; or sending MSG3, where the logical channel identifier (LCID) in the media access control (MAC) subheader corresponding to MSG3 is a first predetermined value; the first predetermined value is configured to indicate waking up a network device or initiating the first service.

In some embodiments, the first service includes at least one of the following: an emergency call service, a high-priority service, a first-priority service, an MSC service, an MPS service, a voice service, a video service, or an SMS service. Alternatively, the first-priority service has a higher priority than the second-priority service.

In some embodiments, the terminal is a second terminal; the method includes one of the following: sending MSG1, where the preamble code of MSG1 is a second predetermined preamble code, the second predetermined preamble code being configured to indicate whether the second terminal supports NES capability; sending MSG1, where the predetermined RACH resource of MSG1 is configured to indicate whether the second terminal supports NES capability; sending MSG3, where the LCID in the MAC subheader corresponding to MSG3 is a second predetermined value, the second predetermined value being configured to indicate whether the second terminal supports NES capability; or sending MSG3, where the second predetermined bit of MSG3 is configured to indicate whether the second terminal supports NES capability.

In some embodiments, the method further includes receiving second information, where the second information indicates at least one of the following: the cell deactivating NES mode, the cell deconfiguring NES mode, the cell exiting NES mode, the first duration of the cell being awake being one or more DTX cycles, the first duration of keeping the network device awake being one or more DTX cycles, or the cell being awakened in the most recent one or more DTX cycles.

In some embodiments, receiving the first information includes one of the following: receiving the first information via a system message; or receiving the first information via an RRC signaling.

In some embodiments, receiving the second information includes one of the following: receiving the second information via a system message; or receiving the first information via an RRC signaling.

The above embodiments may be implemented individually or in combination. An alternative implementation may be found in the alternative implementations of the steps in FIG. 2 and FIG. 4A and are not further described here.

FIG. 4C is a flowchart illustrating an information processing method according to an embodiment of the present disclosure. As shown in FIG. 4C, the embodiment of the present disclosure relates to an information processing method, performed by a network device, including step S4301.

Step S4301: sending at least one of the following: MSG1, MSG3, or a paging message.

Alternative implementation(s) of step S4301 may be found in the alternative implementations in step S2103 in FIG. 2 or step S4102 in FIG. 3A, as well as other related portions of the embodiments involved in FIG. 2 and FIG. 4A and are not further described here.

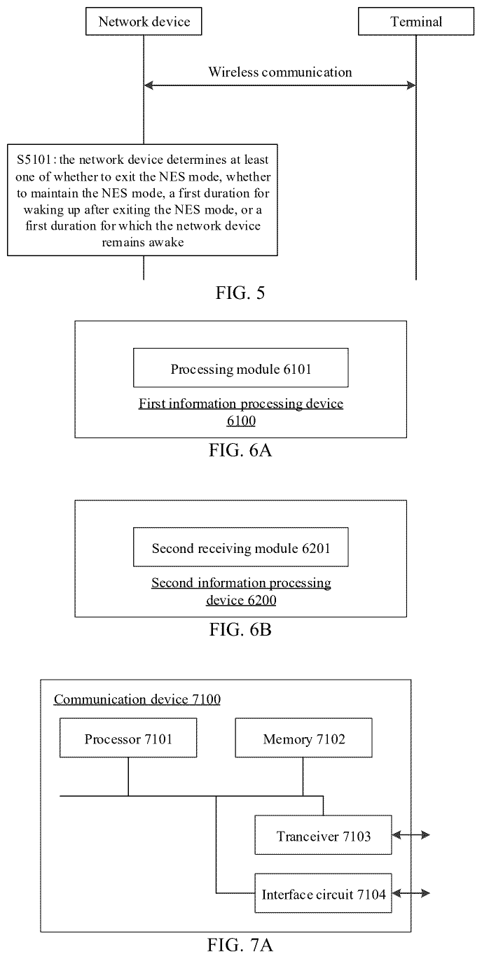

FIG. 5 is a flow chart illustrating an information processing method according to an embodiment of the present disclosure. As shown in FIG. 5, the embodiment of the present disclosure relates to an information processing method for an information processing system 100. The method includes step S5101.

Step S5101: the network device determines at least one of whether to exit the NES mode, whether to maintain the NES mode, a first duration for waking up after exiting the NES mode, or a first duration for which the network device remains awake.

Alternatively, the network device determines at least one of whether to exit the NES mode, whether to maintain the NES mode, a first duration for waking up after exiting the NES mode, or a first duration for which the network device remains awake based on at least one of whether the terminal supports an NES capability or a determination that the terminal triggers a service.

In some embodiments, the network device sends first information to the terminal. In some embodiments, the terminal sends at least one of the following to the network device: MSG1, MSG3, or a paging message. In some embodiments, the network device sends second information to a third terminal. Alternatively, the third terminal may be the first terminal or the second terminal. Alternatively, the third terminal may be a terminal other than the first terminal or the second terminal.

Alternative implementations of step S5101 can be found in the alternative implementations of step S2103 of FIG. 2 and step S3103 of FIG. 3A and other related portions of the embodiments involved to FIG. 2 and FIG. 3A, and are not further described here.

In some embodiments, the above method may include the methods described in the above-mentioned embodiments of the information processing system 100, network device, terminal, etc., and are not further described here.

The embodiments of the present disclosure relate to an information processing method, which includes the following steps.

In some embodiments, the network side indicates NES-related information. Alternatively, the network side may be the network device described in the previous embodiments.

Alternatively, the network side indicates whether a cell is in network energy saving mode (NES mode) or non-network energy saving mode (non-NES mode), or whether the cell supports NES mode or not by system broadcast information.

Alternatively, the network side configures NES-related parameters by system broadcast to indicate whether a cell is in NES mode or non-NES mode, or whether the cell supports NES mode or not. For example, NES-related parameters may include, but are not limited to, at least one of the following: cell DTX and/or cell DRX configuration parameters; such as a cycle, an offset, and/or an on-duration length, etc.

In some embodiments, a terminal initiating an emergency call triggers the network side to exit NES mode. Alternatively, the network side may be the network device described in the previous embodiments.

Alternatively, an NES mode cell may indicate via system broadcast whether an emergency call can wake up the network or whether emergency call initiation is supported.

Alternatively, a terminal residing in an NES mode cell initiates an emergency call. The network side recognizes that the terminal has initiated an emergency call by the following methods and then exits NES mode: Method 1: the cause value in the received MSG3 is “emergency”; Method 2: the preamble code in the received MSG1 is a preamble reserved for waking up the network side or indicating the initiation of an emergency call service; and/or Method 3: The LCID in the MAC packet header corresponding to the MSG3 SUD in the TB containing the received MSG3 is a specific LCID. The LCID is configured to indicate waking up the network side or initiating an emergency call service. Alternatively, the packet header can be the sub-header described in the previous embodiment.

Alternatively, the network side notifies other terminals that NES mode is deactivated or deconfigured, or that the cell exits NES mode. Alternatively, the other terminal can be the third terminal described in the previous embodiment.

In some embodiments, a legacy UE or a non-NES-capable UE terminal triggers the network side to leave NES mode. Alternatively, the network side can be the network device described in the previous embodiment.

For an NES-capable UE residing in an NES-mode cell, when UL traffic is triggered or a paging message is received, the terminal is triggered to initiate a random access procedure and performs an RRC connection establishment procedure. Then: Method 1: The preamble code in the received MSG1 and/or RACH are reserved to indicate that the terminal supports NES capability. Method 2: The LCID in the MAC header corresponding to the MSG3 SUD in the TB containing the received MSG3 is a specific LCID. The LCID indicates that the terminal supports NES capability. Method 3: The reserved bit in the received MSG3 indicates that the terminal supports NES capability. For example, the reserved bit is set to 1.

Alternatively, when the network side identifies that the terminal supports NES capability and the current cell is in NES mode, the network side is not awakened or maintains NES mode.

Alternatively, for an NES non-capable UE and/or a legacy UE residing in an NES mode cell, when UL traffic is triggered or a paging message is received, the terminal is triggered to initiate a random access procedure and performs an RRC connection establishment procedure. When the network side identifies that the terminal does not support NES capability, that is, the current terminal is an NES non-capable UE and/or a legacy UE, and the current cell is in NES mode, the network side is awakened or exits NES mode.

Alternatively, the network side notifies other terminals that NES mode is deactivated or deconfigured, or that the cell exits NES mode. Alternatively, the other terminal may be the third terminal described in the previous embodiment.

In the embodiments of the present disclosure, some or all of the steps and their alternative implementations may be arbitrarily combined with some or all of the steps in other embodiments, or with the alternative implementations of other embodiments.

The embodiments of the present disclosure also provide a device for implementing any of the above methods. For example, a device is provided that includes units for implementing the steps performed by a terminal in any of the above methods. For another example, another device is provided that includes units for implementing the steps performed by a network device in any of the above methods.

It should be understood that the division of the units in the above device is merely a division of logical functions. In actual implementation, they may be fully or partially integrated into a single physical entity, or physically separated. Furthermore, the units in the device may be implemented in the form of a processor invoking software: for example, the device includes a processor connected to a memory, the memory storing computer instructions, and the processor invoking the computer instructions stored in the memory to implement any of the above methods or the functions of respective units of the device. The processor is, for example, a general-purpose processor, such as a central processing unit (CPU) or a microprocessor, and the memory is a memory within the device or a memory external to the device. Alternatively, the units in the device may be implemented in the form of hardware circuits, and the functions of some or all of the units may be implemented by designing the hardware circuits. The hardware circuits may be understood as one or more processors. For example, in one implementation, the hardware circuits may be an application-specific integrated circuit (ASIC), and the functions of some or all of the above units may be implemented by designing the logical relationships between the components within the circuits. For example, in another implementation, the hardware circuits may be implemented by a programmable logic device (PLD), such as a field programmable gate array (FPGA), which may include a large number of logic gate circuits. The connections between the logic gate circuits are configured through a configuration file to implement the functions of some or all of the above units. All units of the above device may be implemented entirely through a processor invoking software, entirely through hardware circuits, or partially through a processor invoking software, with the remainder implemented through hardware circuits.

In the embodiments of the present disclosure, a processor is a circuit with signal processing capabilities. In one implementation, the processor may be a circuit capable of reading and executing instructions, such as a central processing unit (CPU), a microprocessor, a graphics processing unit (GPU) (which can be understood as a type of microprocessor), or a digital signal processor (DSP). In another implementation, the processor may implement certain functions through the logical relationships of hardware circuits, where the logical relationships of such hardware circuits are fixed or reconfigurable. For example, the processor may be a hardware circuit implemented as an application-specific integrated circuit (ASIC) or a programmable logic device (PLD), such as an FPGA. In a reconfigurable hardware circuit, the process of the processor loading a configuration file to implement hardware circuit configuration can be understood as the process of the processor loading instructions to implement the functions of some or all of the above units. In addition, it can also be a hardware circuit designed for artificial intelligence, which can be understood as an ASIC, such as a neural network processing unit (NPU), a tensor processing unit (TPU), a deep learning processing unit (DPU), etc.

FIG. 6A is a schematic diagram of a structure of a first information processing device 6100 provided by an embodiment of the present disclosure. As shown in FIG. 6A, the first information processing device 6100 includes a processing module 6101 configured to determine at least one of whether the network device exits NES mode, whether the network device maintains NES mode, a first duration for waking up after exiting NES mode, or the first duration for which the network device remains awake. Alternatively, the processing module 6101 is configured to perform the processing-related steps performed by the first network element in any of the described methods, which are not further described here. Alternatively, the first information processing device 6100 further includes a first sending module (not shown). The first sending module is configured to perform the sending-related steps performed by the network device in any of the methods, which are not further described here. Alternatively, the first information processing module 6101 further includes a first receiving module (not shown). The first receiving module is configured to perform the receiving-related steps performed by the network device in any of the methods.

In some embodiments, the processing module 6101 or any other processing module may include a processor, CPU, GPU, computer, etc., and these terms are interchangeable.

FIG. 6B is a schematic diagram of a structure of a second information processing device 6200 provided by an embodiment of the present disclosure. As shown in FIG. 6B, the second information processing device 6200 includes a second receiving module 6201 configured to receive first information. Alternatively, the second receiving module 6201 is configured to perform the reception-related steps performed by the terminal in any of the described methods, which are not described in detail here. Alternatively, the second information processing device 6200 further includes a second sending module (not shown) that is configured to perform the transmission-related steps performed by the terminal in any of the methods, which are not described in detail here.

In some embodiments, the first receiving module and/or second receiving module 6201 may include a receiver and a transmitter (neither shown), which may be separate or integrated. Alternatively, terms such as transceiver, transceiver module, transceiver unit, transceiver machine, transceiver circuit, etc. are interchangeable; terms such as transmitter, transmitting unit, transmitter machine, transmitting circuit, etc. are interchangeable; and terms such as receiver, receiving module, receiving unit, receiver machine, receiving circuit, etc. are interchangeable.

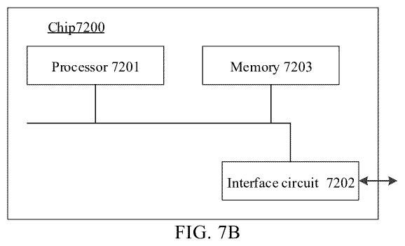

FIG. 7A is a schematic structural diagram of a communication device 7100 provided in an embodiment of the present disclosure. The communication device 7100 may be a network device (e.g., an access network device, a core network device, etc.), a terminal (e.g., a user equipment), or a chip, a chip system, or a processor that supports a network device implementing any of the above methods, or a chip, a chip system, or a processor that supports a terminal implementing any of the above methods. The communication device 7100 may be configured to implement the methods described in the method embodiments. For details, please refer to the description of the provided method embodiments.

As shown in FIG. 7A, the communication device 7100 includes one or more processors 7101. The processor 7101 may be a general-purpose processor or a dedicated processor, such as a baseband processor or a central processing unit. The baseband processor can be configured to process communication protocols and communication data, while the central processing unit can be configured to control communication devices (such as base stations, baseband chips, terminal devices, terminal device chips, DUs or CUs), execute programs, and process program data. The processor 7101 is configured to invoke instructions to cause the communication device 7100 to perform any of the described methods.

In some embodiments, the communication device 7100 further includes one or more memories 7102 for storing instructions. Alternatively, all or part of the memories 7102 may be located outside the communication device 7100.

In some embodiments, the communication device 7100 further includes one or more transceivers 7103. When the communication device 7100 includes one or more transceivers 7103, the communication steps such as sending and receiving in the above methods are performed by the transceiver 7103, while other steps are performed by the processor 7101.

In some embodiments, the transceiver 7103 may include a receiver and a transmitter (neither shown), which may be separate or integrated. Alternatively, terms such as transceiver, transceiver unit, transceiver machine, transceiver circuit, etc. are interchangeable; terms such as transmitter, transmitting unit, transmitter machine, transmitting circuit, etc. are interchangeable; and terms such as receiver, receiving unit, receiver machine, receiving circuit, etc. are interchangeable.

Alternatively, the communication device 7100 further includes one or more interface circuits 7104, which are connected to the memory 7102 and can be configured to receive signals from the memory 7102 or other devices, and can be configured to send signals to the memory 7102 or other devices. For example, the interface circuit 7104 can read instructions stored in the memory 7102 and send the instructions to the processor 7101.

The communication device 7100 described in the embodiments may be a network device or a terminal, but the scope of the communication device 7100 described in the present disclosure is not limited thereto, and the structure of the communication device 7100 may not be limited to that shown in FIG. 7A. The communication device may be an independent device or part of a larger device. For example, the communication device may be: (1) an independent integrated circuit IC, or a chip, or a chip system or subsystem; (2) a collection of one or more ICs. Alternatively, the above IC collection may also include a storage component for storing data or computer programs; (3) an ASIC, such as a modem; (4) a module that can be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc.; (6) others, etc.

FIG. 7B is a schematic diagram of a structure of a chip 7200 provided in an embodiment of the present disclosure. For the case where the communication device 7100 may be a chip or a chip system, reference may be made to the schematic diagram of the structure of the chip 7200 shown in FIG. 7B, but the present disclosure is not limited thereto.

The chip 7200 includes one or more processors 7201, and the processor 7201 is configured to call computer instructions so that the chip 7200 executes any of the described methods.

In some embodiments, the chip 7200 further includes one or more interface circuits 7202 connected to the memory 7203. The interface circuits 7202 can receive signals from the memory 7203 or other devices, or can send signals to the memory 7203 or other devices. For example, the interface circuit 7202 can read instructions stored in the memory 7203 and send these instructions to the processor 7201. Terms such as interface circuit, interface, transceiver pin, transceiver, etc. are interchangeable.

In some embodiments, the chip 7200 further includes one or more memories 7203 for storing computer instructions. Alternatively, all or part of the memory 7203 may be located external to chip 7200.

The present disclosure also provides a storage medium storing instructions that, when executed on the communication device 7100, cause the communication device 7100 to perform any of the described methods. Alternatively, the storage medium is an electronic storage medium. Alternatively, the storage medium is a non-transitory computer-readable storage medium, but is not limited thereto and may also be a storage medium readable by other devices. Alternatively, the storage medium may be a non-transitory storage medium, but is not limited thereto and may also be a transitory storage medium.

The present disclosure also provides a program product that, when executed by the communication device 7100, causes the communication device 7100 to perform any of the above methods. Alternatively, the program product is a computer program product.

The present disclosure also provides a computer program that, when executed on a computer, causes the computer to perform any of the described methods.

1. An information processing method, performed by a network device, comprising:
determining, based on at least one of whether a terminal supports a Network Energy Saving (NES) capability or a determination that the terminal triggers a service, at least one of:
whether the network device exits an NES mode,
whether the network device maintains the NES mode,
a first duration for waking up after exiting the NES mode, or
the first duration for keeping the network device awake, and
wherein the terminal resides in a cell in the NES mode.

2. The method according to claim 1, further comprising:
sending first information indicating at least one of:
whether the cell corresponding to the network device is in the NES mode; or
whether the cell supports the NES mode.

3. The method according to claim 2, wherein the first information comprises at least one of:
a Discontinuous Transmission (DTX) parameter, the DTX parameter comprising at least one of: a DTX cycle, a DTX offset, or DTX monitoring time; or
a Discontinuous Reception (DRX) parameter, the DRX parameter comprising at least one of: a DRX cycle, a DRX offset, or DRX monitoring time.

4. The method according to claims 1, further comprising:
receiving at least one of: a message 1 (MSG1), a message 3 (MSG3), or a paging message.

5. The method according to claim 1, wherein the terminal is a first terminal; and
determining, based on at least one of whether the terminal supports the NES or the determination that the terminal triggers the service, at least one of whether the network device exits NES mode, whether the network device maintains NES mode, the first duration for waking up after exiting NES mode, or the first duration for keeping the network device awake comprises at least one of:
determining to exit the NES mode based on determining that the first terminal initiates a first service;
determining the first duration for waking up after exiting NES mode based on determining that the first terminal initiates the first service; or
determining the first duration for keeping the network device awake based on determining that the first terminal initiates the first service.

6. (canceled)

7. The method according to claim 5, wherein the method further comprises: receiving at least one of: a message 1 (MSG1), a message 3 (MSG3), or a paging message, and
wherein determining that the first terminal initiates the first service comprises at least one of:
determining that the first terminal initiates the first service based on a preamble code of the MSG1 being a first predetermined preamble code, wherein the first predetermined preamble code is configured to indicate waking up the network device or initiating the first service;
determining that the first terminal initiates the first service based on the MSG3 and a first predetermined bit of the MSG3 being configured to indicate that the first terminal initiates the first service; or
determining that the first terminal initiates the first service based on a logical channel identifier (LCID) in a media access control (MAC) subheader corresponding to the MSG3 being a first predetermined value, and wherein the first predetermined value is configured to indicate waking up the network device or initiating the first service.

8. The method according to claim 1, wherein
the terminal is a second terminal, and
determining, based on at least one of whether the terminal supports the NES capability or the determination that the terminal triggers the service, at least one of whether the network device exits the NES mode, whether the network device maintains the NES mode, the first duration for waking up after exiting the NES mode, or the first duration for keeping the network device awake comprises one of:
determining to maintain the NES mode based on the second terminal supporting the NES capability;
determining to maintain the NES mode based on the second terminal supporting the NES capability and determining that the second terminal initiates a second service;
determining to maintain the NES mode based on the second terminal supporting the NES capability and determining that the second terminal receives a paging message;
determining at least one of exiting the NES mode, the first duration for waking up after exiting the NES mode or the first duration for keeping the network device awake based on the second terminal supporting the NES capability;
determining to maintain the NES mode based on the second terminal not supporting the NES capability;
determining at least one of exiting the NES mode, the first duration for waking up after exiting the NES mode, or the first duration for keeping the network device awake based on the second terminal not supporting the NES capability;
determining at least one of exiting the NES mode, the first duration for waking up after exiting the NES mode, or the first duration for keeping the network device awake based on the second terminal not supporting the NES capability and determining that the second terminal initiates the second service; or
determining at least one of exiting the NES mode, the first duration for waking up after exiting the NES mode, or the first duration for keeping the network device awake based on the second terminal not supporting the NES capability and determining that the second terminal receives a paging message.

9. (canceled)

10. The method according to claim 8, wherein the method comprises at least one of:
determining whether the second terminal supports the NES capability based on a preamble code of a message 1 (MSG1) being a second predetermined preamble code, wherein the second predetermined preamble code is configured to indicate whether the second terminal supports the NES capability;
determining whether the second terminal supports the NES capability based on a predetermined random access channel (RACH) resource of the MSG1, wherein the predetermined RACH resource is configured to indicate whether the second terminal supports the NES capability;
determining whether the second terminal supports the NES capability based on a logical channel identifier (LCID) in a media access control (MAC) subheader corresponding to a message 3 (MSG3), wherein the LCID is a second predetermined value, and the second predetermined value is configured to indicate whether the second terminal supports the NES capability; or
determining whether the second terminal supports the NES capability based on a second predetermined bit of a message 3 (MSG3), wherein the second predetermined bit is configured to indicate whether the second terminal supports the NES capability.

11. The method according to, claim 4 further comprises:
sending second information to a third terminal based on the network device exiting the NES mode, the second information being configured to indicate at least one of:
the cell deactivating the NES mode;
the cell deconfiguring the NES mode;
the cell exiting the NES mode;
the first duration for which the cell is awake being one or more Discontinuous Transmission (DTX) cycles;
the first duration for keeping the network device awake being one or more Discontinuous Transmission (DTX) cycles; or
the cell being awakened during most recent one or more Discontinuous Transmission (DTX) cycles.

12.-13. (canceled)

14. An information processing method, performed by a terminal, comprising:
receiving first information, the first information indicating at least one of:
whether a cell corresponding to a network device is in a Network Energy Saving (NES) mode, or
whether the cell supports the NES mode.

15. The method according to claim 14, wherein the first information comprises at least one of:
a Discontinuous Transmission (DTX) parameter, the DTX parameter comprising at least one of: a DTX cycle, a DTX offset, or DTX monitoring time; or
a Discontinuous Reception (DRX) parameter, the DRX parameter comprising at least one of: a DRX cycle, a DRX offset, or DRX monitoring time.

16. The method according to claim wherein the terminal is a first terminal;, and the method further comprises one of:
sending a message 1 (MSG1), wherein a preamble code of the MSG1 is a first predetermined preamble code; the first predetermined preamble code is configured to indicate waking up the network device or initiating a first service;
sending a message 3 (MSG3), wherein a first predetermined bit of the MSG3 is configured to indicate that the first terminal initiates the first service; or
sending a message 3 (MSG3), wherein a logical channel identifier (LCID) in a media access control (MAC) subheader corresponding to the MSG3 is a first predetermined value;, and the first predetermined value is configured to indicate waking up the network device or initiating the first service.

17. (canceled)

18. The method according to claim 14 wherein the terminal is a second terminal, the method further comprises one of:
sending a message 1 (MSG1), wherein a preamble code of the MSG1 is a second predetermined preamble code, and the second predetermined preamble code is configured to indicate whether the second terminal supports the NES capability;
sending a message 1 (MSG1), wherein a predetermined random access channel (RACH) resource of the MSG1 is configured to indicate whether the second terminal supports the NES capability;
sending a message 3 (MSG3), wherein a logical channel identifier (LCID) in a media access control (MAC) subheader corresponding to the MSG3 is a second predetermined value, and the second predetermined value is configured to indicate whether the second terminal supports the NES capability; or
sending a message 3 (MSG3), wherein a second predetermined bit of the MSG3 is configured to indicate whether the second terminal supports the NES capability.

19. The method according to claim 16, wherein the method further comprises:
receiving second information, the second information being configured to indicate at least one of:
the cell deactivating the NES mode;
the cell deconfiguring the NES mode;
the cell exiting the NES mode;
the first duration for which the cell is awake being one or more Discontinuous Transmission (DTX) cycles;
the first duration for keeping the network device awake being one or more Discontinuous Transmission (DTX) cycles; or
the cell being awakened during a most recent one or more Discontinuous Transmission (DTX) cycles.

21. (canceled)

22. An information processing method, for a communication system comprising a network device and a terminal, comprising:
determining, via the network device, based on at least one of a whether the terminal supports a Network Energy Saving (NES) capability or a determination that the terminal triggers the service, at least one of
whether the network device exits an NES mode,
whether the network device maintains the NES mode,
a first duration for waking up after exiting the NES mode, or
the first duration for keeping the network device awake; and
wherein the terminal resides in a cell in the NES mode.

23. The method according to claim 22, wherein
sending, via the network device, first information to the terminal, and the first information indicates at least one of:
whether the cell corresponding to the network device is in the NES mode; or
whether the cell supports the NES mode.

24. The method according to claim 22, wherein
the terminal is a first terminal; and
determining, via the network device, based on at least one of whether the terminal supports the NES capability or the determination that the terminal triggers the service, at least one of whether the network device exits the NES mode, whether the network device maintains the NES mode, the first duration for waking up after exiting the NES mode, or the first duration for keeping the network device awake, comprises at least one of:
the network device determining to exit the NES mode based on determining that the first terminal initiates a first service;
the network device determining the first duration for waking up after exiting the NES mode based on determining that the first terminal initiates the first service; or
the network device determining the first duration for keeping the network device awake based on determining that the first terminal initiates the first service.

25. The method according to claim 22, wherein
the terminal is a second terminal;
determining, via the network device, based on at least one of whether the terminal supports the NES capability or the determination that the terminal triggers the service, determining at least one of whether the network device exits the NES mode, whether the network device maintains the NES mode, the first duration for waking up after exiting the NES mode, or the first duration for keeping the network device awake, comprises at least one of:
determining to maintain the NES mode based on the second terminal supporting the NES capability;
determining to maintain the NES mode based on the second terminal supporting the NES capability and determining that the second terminal initiates a second service;
determining to maintain the NES mode based on the second terminal supporting the NES capability and determining that the second terminal receives a paging message;
determining at least one of exiting the NES mode, the first duration for waking up after exiting the NES and the first duration for keeping the network device awake based on the second terminal supporting the NES capability;
determining to maintain the NES mode based on the second terminal not supporting the NES capability;
determining at least one of exiting the NES mode, the first duration for waking up after exiting the NES mode, and the first duration for keeping the network device awake based on the second terminal not supporting the NES capability;
determining at least one of exiting the NES mode, the first duration for waking up after exiting the NES mode, and the first duration for keeping the network device awake based on the second terminal not supporting the NES capability and determining that the second terminal initiates the second service; or
determining at least one of exiting the NES mode, the first duration for waking up after exiting the NES mode, and the first duration for keeping the network device awake based on the second terminal not supporting the NES capability and determining that the second terminal receives a paging message.

26.-27. (canceled)

28. A communication device, comprising:
one or more processors, and
wherein the one or more processors are configured to invoke instructions to cause the communication device to perform the information processing method according to claim 1.

29.-30. (canceled)

31. A communication device, comprising:
one or more processors and
wherein the one or more processors are configured to invoke instructions to cause the communication device to perform the information processing method according to claim 14.
